(19) United States
(12) Patent Application Publication
(10) Pub. No.: US 2024/0276605 A1
(43) Pub. Date: Aug. 15, 2024

(54) APPARATUS AND METHOD FOR STYLING HAIR

(71) Applicant: JEMELLA LIMITED, London (GB)

(72) Inventors: Robert Alexander WEATHERLY, London (GB); Liam Henry WRIGHT, London (GB); Aziz TOKGOZ, London (GB); Abbasi GANDHI, Harston (GB); Raja KHAN, Harston (GB)

(21) Appl. No.: 18/641,014

(22) Filed: Apr. 19, 2024

Related U.S. Application Data
(63) Continuation of application No. PCT/GB2022/052597, filed on Oct. 12, 2022.

(30) Foreign Application Priority Data
Oct. 22, 2021 (GB) 2115266.5

(51) Int. Cl. H05B 3/26; A45D 1/04

(52) U.S. Cl. CPC H05B 3/262; A45D 1/04; H05B 2203/003; H05B 2203/013; H05B 2203/03

(57) ABSTRACT

A heater assembly is for a hair styling device. The heater assembly includes a substrate, and at least one conductor layer, the at least one conductor layer having at least one heater track through which current can flow to heat the substrate. At least one electrically insulating layer is between the at least one conductor layer and the substrate. The at least one heater track is formed of a silver-based material. The at least one electrically insulating layer is configured to prevent electrical breakdown between the at least one conductor layer and the substrate.

### CROSS-REFERENCE TO RELATED APPLICATIONS

This application is a Continuation of PCT/GB2022/052597, filed Oct. 12, 2022, which claims benefit of Great Britain Application No. 2115266.5, filed Oct. 22, 2021, and which applications are incorporated herein by reference. To the extent appropriate, a claim of priority is made to each of the above disclosed applications.

### FIELD OF THE INVENTION

The present invention relates to an apparatus and method for styling hair. The hair may be human or non-human hair. The invention may be used to style dry hair or wet (or “towel-dry”) hair. Such styling of the hair may be performed by a user in respect of their own hair, for example, or by another user such as a hair stylist.

### BACKGROUND TO THE INVENTION

Conventional flat-plate hair stylers that incorporate a pair of heated plates are well known. In use, a tress of hair is placed between the plates, and heat transferred from the plates to the hair enables styling of the hair. For example, the user may achieve a straightening or curling effect.

As shown in the simplified schematic illustration of FIG. 1a, a heater assembly of a conventional flat plate hair styler utilises a heater element 11 to heat a hair contacting plate 12 that contacts the hair during use. The heater element 11 is provided between the hair contacting plate 12 and a heater carrier 14. The assembly 10 is held together by steel clips (not shown in the figure). In order to achieve sufficient thermal transfer from the heater element 11 to the hair contacting plate 12, a thermal interface material 13 is typically provided between the heater element 11 and the hair contacting plate 12, as illustrated in FIG. 1b. Including the heater carrier 14, the thickness of the heater assembly is approximately 12 mm. This makes for a relatively bulky heater assembly and one having a relatively low energy efficiency, since a significant portion of the heat energy is wasted as it traverses the interface(s) between the heater element 11 and the hair contacting plate 12, even when the thermal interface material 13 is provided. Moreover, the heater assembly of a typical commercialised flat plate styler has a relatively high thermal mass (typically greater than 50 J/K, over half of which corresponds to the thermal mass of the heater carrier 14) which means that when the device 10 is first powered on, a large amount of energy is required to increase the temperature of the hair contacting plate 12 to its operating temperature. This results in a significant delay between the user switching on the device 10 and the hair contacting plate 12 reaching a sufficiently high temperature for the user to begin styling the hair (this delay is known as ‘thermal lag’), and also increases the amount of power required to maintain the hair contacting surface 12 at its operating temperature.

An alternative, less bulky, configuration of a heater assembly for a hair styling device is described in GB2447750. The heater assembly comprises a thick film printed heating element for a battery powered device which is used to heat up the hair contacting surface. However, there is a need for further improvements to such heater assemblies. For example, a thick film printed heater is relatively delicate compared to conventional heating arrangements, increasing the difficulty of forming strong and reliable electrical connections to the heater. Moreover, there is a desire to further improve the thermal properties of such devices by further reducing the thermal lag, and by improving temperature distribution across the hair-contacting surface when the device is in operation.

### SUMMARY OF THE INVENTION

According to a first aspect of the invention, there is provided a heater assembly for a hair styling device, the heater assembly comprising: a substrate; at least one conductor layer, the at least one conductor layer comprising at least one heater track through which current can flow to heat the substrate; and at least one electrically insulating layer between the at least one conductor layer and the substrate; wherein the at least one heater track is formed of a silver-based material; and wherein the at least one electrically insulating layer is configured to prevent electrical breakdown between the at least one conductor layer and the substrate.

The total thickness of the at least one electrically insulating layer may be between 0.02 mm and 0.05 mm.

A surface of the substrate facing the at least one electrically insulating layer may have a mean roughness of less than or equal to 0.2 μm. A surface of the substrate facing the at least one electrically insulating layer may have a mean roughness depth of less than or equal to 1.4 μm. According to a second aspect of the invention, there is provided a heater assembly for a hair styling device, the heater assembly comprising: a substrate; at least one conductor layer, the at least one conductor layer comprising at least one heater track through which current can flow to heat the substrate; and at least one electrically insulating layer between the at least one conductor layer and the substrate; wherein the at least one electrically insulating layer is configured to prevent electrical breakdown between the at least one conductor layer and the substrate; wherein the total thickness of the at least one electrically insulating layer is between 0.02 mm and 0.05 mm; and wherein a surface of the substrate facing the at least one electrically insulating layer has a mean roughness of less than or equal to 0.2 μm or has a mean roughness depth of less than or equal to 1.4 μm.

The at least one heater track may be formed of a silver-based material. The at least one heater track may be formed of a material comprising at least 90% silver.

The material preferably comprises 1% to 10% of a dielectric material that can bond with the dielectric layer on which the conductor layer is formed.

The resistance of a heater track of the at least one heater track may be between 0.3Ω and 0.9Ω.

The at least one electrically insulating layer may comprise two electrically insulating layers; wherein a first electrically insulating layer of the two electrically insulating layers has a thickness of between 0.010 mm and 0.025 mm; and wherein a second electrically insulating layer of the two electrically insulating layers has a thickness of between 0.010 mm and 0.025 mm. Typically, each insulating layer is a uniform layer of dielectric material.

The at least one electrically insulating layer may be screen printed or deposited using a physical vapour deposition, PVD, process. The at least one electrically insulating layer may be formed of a dielectric material. The dielectric material may be a silica based material.

The substrate may be elongate; and a heater track of the at least one heater tracks may extend longitudinally along the elongate substrate and have a non-constant width along the length of the substrate.

According to a third aspect of the invention, there is provided a heater assembly for a hair styling device, the heater assembly comprising: a substrate; at least one conductor layer mounted to the substrate, the at least one conductor layer comprising conductors that define at least one heater track through which current can flow to heat the substrate; and connection circuitry for connecting the at least one heater track to power control circuitry for causing current to flow through the at least one heater track; wherein the connection circuitry includes a conductive member that is ultrasonically bonded to the at least one heater track. Beneficially, the ultrasonic bond provides a strong and reliable electrical connection.

The heater assembly may further comprise: an intermediate connection member, wherein the conductive member is ultrasonically bonded to a first connection terminal of the intermediate connection member, to electrically connect the at least one heater track to the first connection terminal, wherein the intermediate connection member comprises a second connection terminal that is electrically connected to the first connection terminal, and wherein the power control circuitry is electrically connected to the second connection terminal for causing current to flow through the at least one heater track via the intermediate connection part.

The conductive member may be a ribbon of conductive material, and the conductive member may be ribbon bonded to the at least one heater track. The ribbon may be aluminium ribbon.

The ribbon may have a thickness of between 100 μm and 500 μm, preferably 400 μm. The ribbon may have a width of between 1 mm and 2 mm.

The ribbon between the ultrasonic bond to the heater track and the first connection terminal may have a loop portion. The length of the ribbon between the ultrasonic bond to the heater track and the first connection terminal may be substantially longer than the shortest connection path between the ultrasonic bond to the heater track and the first connection terminal. Beneficially, the loop portion reduces the strain on the electrical connection when there is relative movement between the heater track and the first connection terminal.

The conductive member may be ultrasonically bonded at a plurality of discrete connection points to a connection terminal of the at least one heater track. A plurality of the conductive members may be ultrasonically bonded to a single connection terminal of the at least one heater track. Beneficially, by bonding the conductive member at a plurality of discrete locations, and/or by bonding a plurality of conductive members to a single connection terminal, the risk of failure of the connection is reduced.

The heater assembly may further comprise at least one dielectric layer between the substrate and the at least one conductor layer. The at least one dielectric layer may have a total thickness of between 0.02 mm and 0.05 mm.

The at least one dielectric layer may comprise two dielectric layers; wherein a first dielectric layer of the two dielectric layers has a thickness of between 0.010 mm and 0.025 mm; and wherein a second dielectric layer of the two dielectric layers has a thickness of between 0.010 mm and 0.025 mm.

The at least one heater track may comprise: a power supply unit, PSU, heater track that is connected to the power control circuitry for flow of current derived from a mains power source; and a battery heater track that is connected to the power control circuitry for flow of current derived from a battery power source. The average width of the battery heater track may be greater than the average width of the PSU heater track.

The substrate may be elongate; the PSU heater track may extend longitudinally along the elongate substrate; and a width of the PSU track decreases away from an end of the substrate. The PSU heater track and the battery heater track may be interleaved with each other. The PSU heater track and the battery heater track may share a common ground terminal.

The substrate may be formed of an aluminium alloy. The substrate may have a thickness of between 1 mm and 2 mm. The substrate may have a mean roughness less than or equal to 0.2 μm. The substrate may have a mean roughness depth less than or equal to 1.4 μm.

The at least one conductor layer may have a total thickness of between 0.01 mm and 0.03 mm. The at least one conductor layer may be screen printed or deposited using a physical vapour deposition, PVD, process.

The resistance of a heater track of the at least one heater track may be between 0.3 Q and 0.9 Q.

According to a fourth aspect of the invention, there is provided a heater assembly comprising: an elongate substrate; and at least one conductor layer mounted to a surface of the substrate, the at least one conductor layer comprising a plurality of conductors that define at least one heater track through which current can flow to heat said substrate; wherein said plurality of conductors includes one or more conductors that extend longitudinally along the elongate substrate and which have a non-constant width along the length of the substrate. Beneficially, the non-constant width of the conductors improves the heat distribution of the heater assembly.

The width of said one or more conductors may decrease in width away from an end of the elongate substrate.

The at least one conductor layer mounted to said surface of the substrate may comprise a plurality of conductors that define a first heater track and a second heater track through which current can flow to heat said substrate, wherein at least one conductor that defines the first heater track extends along the length of the substrate and has a larger width in a central part of the elongate substrate than its width in an end part of the elongate substrate, and wherein at least one conductor that defines the second heater track extends along the length of the substrate and has a larger width in the end part of the elongate substrate than its width in the central part of the elongate substrate.

The first heater track and the second heater track may be interleaved with each other. The second heater track may run substantially parallel to the first heater track.

The first heater track may be a power supply unit, PSU, heater track that is for receiving current derived from a mains power source, and the second heater track may be a battery heater track that is for receiving current derived from a battery power source. The average width of the second heater track may be greater than the average width of the first heater track.

The heater assembly may further comprise at least one dielectric layer between the substrate and the at least one conductor layer to electrically insulate the substrate from the at least one conductor layer.

The at least one conductor layer may have a total thickness of between 0.01 mm and 0.03 mm. The at least one conductor layer may be screen printed or deposited using a physical vapour deposition, PVD, process.

According to a fifth aspect of the invention, there is provided a hair styling device comprising: a housing; at least one heater assembly for heating hair to be styled; and a mounting clip that mounts the heater assembly to the housing; wherein, the heater assembly comprises: a substrate having a first surface that faces an inner surface of the housing and a second surface that faces away from the housing; and at least one heater track through which current can flow to heat said substrate; wherein the second surface comprises at least one channel extending along the substrate; wherein the mounting clip comprises: a first part that is configured to engage or couple with the housing to attach the mounting clip to the housing; and a second part that is configured to engage with the at least one channel to retain the heater assembly in the housing. Beneficially, the configuration of the mounting clip and heater assembly enables the heater assembly to be to be securely mounted to the hair styling device without obstructing the hair styling surface. Moreover, the configuration of the mounting clip and heater assembly enables a planar first surface of the substrate to be provided (the surface that faces the inner surface of the housing), which enables a screen printing process to be used to print the electrically insulating layer(s) and conductive layer(s) of the heater onto the substrate.

The second surface may comprise a central hair contacting surface and an edge portion; and the edge portion may be recessed relative to the central hair contacting surface so that the hair contacting surface protrudes beyond the second part of the clip when the mounting clip is engaged with the at least one channel.

The edge portion may be recessed relative to the central hair-contacting surface such that the second part of the mounting clip is below the hair contacting surface.

The substrate may include a coating that defines the hair contacting surface.

The second surface may comprise a pair of edge portions, each edge portion comprising a corresponding channel extending along the substrate, and each of the edge portions may be recessed relative to the central hair contacting surface so that the hair contacting surface protrudes beyond the second part of the clip when the mounting clip is engaged with the channels.

The substrate may be elongate. The thermal mass of the mounting clip may be less than 5 J/K.

According to a sixth aspect of the invention, there is provided a hair styling device comprising: a controller (such as a microprocessor or other control circuitry); and at least one heater assembly for heating hair that contacts a hair contacting surface of the heater assembly; wherein the heater assembly comprises a first heater track and a second heater track, and the controller is configured to be able to select either one of the first or second heater tracks to be operated to heat the heater assembly, and to select the other of the first or second heater tracks to be operated as a temperature sensor.

The first heater track may be a power supply unit, PSU, heater track that is connected to power control circuitry for flow of current derived from a mains power source, and the second heater track may be a battery heater track that is connected to power control circuitry for flow of current derived from a battery power source.

According to a seventh aspect of the invention, there is provided a hair styling device comprising one or more heating assemblies according to the first, second, third or fourth aspect of the invention.

The hair styling device may comprise a controller, wherein the at least one heater track comprises a first heater track and a second heater track, and the controller is configured to be able to select either one of the first or second heater tracks to be operated to heat the heater assembly, and to select the other of the first or second heater tracks to be operated as a temperature sensor.

The first heater track may be a power supply unit, PSU, heater track that is connected to power control circuitry for flow of current derived from a mains power source, and the second heater track may be a battery heater track that is connected to power control circuitry for flow of current derived from a battery power source.

According to an eighth aspect of the invention, there is provided a method of manufacturing a heater assembly for a hair styling device, the heater assembly comprising an elongate substrate, the method comprising: screen printing at least one dielectric layer onto the elongate substrate; screen printing a first layer of conductive material onto the at least one dielectric layer to form at least one heater track having a connection terminal for electrical connection to power control circuitry; firing the first layer of conductive material; and after firing the first layer of conductive material, screen printing a second layer of conductive material onto the connection terminal to increase the thickness of conductive material at the connection terminal.

The method may further comprise further screen printing a third layer of conductive material onto the second layer of conductive material to further increase the thickness of conductive material at the connection terminal.

The at least one dielectric layer may have a total thickness of between 0.02 mm and 0.05 mm. The at least one dielectric layer may comprise two dielectric layers; wherein a first dielectric layer of the two dielectric layers has a thickness of between 0.010 mm and 0.025 mm; and wherein a second first dielectric layer of the two dielectric layers has a thickness of between 0.010 mm and 0.025 mm. The first layer of conductive material may have a thickness of between 0.1 mm and 0.03 mm.

According to a ninth aspect of the invention, there is provided a method of manufacturing a heater assembly for a hair styling device, the heater assembly comprising an elongate substrate, the method comprising: screen printing a first dielectric layer onto the elongate substrate; firing the first dielectric layer; after firing the first dielectric layer, screen printing a second dielectric layer onto the first dielectric layer; firing the second dielectric layer; and after firing the second layer of dielectric layer, screen printing a layer of conductive material onto the second dielectric layer to form at least one heater track having a connection terminal for electrical connection to power control circuitry.

The method may further comprise ultrasonically bonding a conductive member to the connection terminal to connect the at least one heater track to the power control circuitry.

The conductive member may be a ribbon of conductive material, and the method may further comprise ribbon bonding the conductive member to the connection terminal to connect the at least one heater track to the power control circuitry. The ribbon may be an aluminium ribbon. The ribbon may have a thickness of between 100 μm and 500 μm. The ribbon may have a width of between 1 mm and 2 mm.

The at least one heater track may include at least one conductor that extends longitudinally along the substrate and whose width varies along the length of the substrate. The resistance of a heater track of the at least one heater track may be between 0.3 Q and 0.9 Q. The at least one heater track may be formed of a material comprising at least 90% silver.

A surface of the substrate facing the at least one dielectric layer may have a mean roughness of less than or equal to 0.2 μm. A surface of the substrate facing the at least one dielectric layer may have a mean roughness depth of less than or equal to 1.4 μm.

According to a tenth aspect of the invention, there is provided a heater assembly comprising: an elongate substrate; and at least one conductor layer mounted to a surface of the substrate, the at least one conductor layer comprising a plurality of conductors that define a first heater track and a second heater track through which current can flow to heat said substrate; wherein at least one conductor that defines the first heater track extends longitudinally along the length of the substrate and has a larger width in a central part of the elongate substrate than its width in an end part of the elongate substrate, and wherein at least one conductor that defines the second heater track extends longitudinally along the length of the substrate and has a larger width in the end part of the elongate substrate than its width in the central part of the elongate substrate.

The first heater track and the second heater track may be interleaved with each other. The second heater track may run substantially parallel to the first heater track. The first heater track may be a power supply unit, PSU, heater track that is for receiving current derived from a mains power source, and the second heater track may be a battery heater track that is for receiving current derived from a battery power source. The average width of the second heater track may be greater than the average width of the first heater track. The heater assembly may further comprise at least one dielectric layer between the substrate and the at least one conductor layer to electrically insulate the substrate from the at least one conductor layer. The at least one conductor layer may have a total thickness of between 0.01 mm and 0.03 mm. The at least one conductor layer may be screen printed or deposited using a physical vapour deposition, PVD, process.

According to an eleventh aspect of the invention, there is provided a hair styling device comprising: a heater assembly for heating hair to be styled or dried; and power supply circuitry for providing electrical power to the heater assembly to heat the heater assembly; wherein the heater assembly comprises: a substrate for heating the hair; first and second elongate conductors mounted on the substrate either side of a heating area of the substrate; and a resistive heating element mounted over, and in thermal contact with, the heating area of the substrate and electrically coupled to the first and second elongate conductors; wherein the power supply circuitry is coupled to the first and second elongate conductors and is arranged to cause current to flow between the first and second elongate conductors through the resistive heating element, to cause the resistive heating element to be heated thereby heating the heating area of the substrate; and wherein the resistive heating element is formed using a physical vapour deposition, PVD, process.

The resistive heating element may comprise a generally planar layer of material arranged between the first elongate conductive element and the second elongate conductive element. The resistive heating element may at least partially overlap the first and second elongate conductors, and the resistive heating element may be formed before the first and second elongate conductors are mounted.

According to a twelfth aspect of the invention, there is provided a method of manufacturing a heater assembly for a hair styling device for heating hair to be styled or dried, the method comprising: forming, using a physical vapour deposition, PVD, process, a resistive heating element mounted over and in thermal contact with a heating area of a substrate; mounting first and second elongate conductors either side of the heating area, wherein the first and second elongate conductors are electrically coupled to the resistive heating element for, in use, current flow between the first and second elongate conductors through the resistive heating element to cause the resistive heating element to be heated, thereby heating the heating area of the substrate; wherein the resistive heating element is formed before the first and second elongate conductors are mounted.

### BRIEF DESCRIPTION OF THE DRAWINGS

Embodiments of the invention will now be described, by way of example only, and with reference to the drawings in which:

FIGS. 1a and 1b show a heater assembly for a conventional hair styling device of the prior art;

FIG. 2a shows an overview of a hair styling device;

FIG. 2b shows the hair styling device shown in FIG. 2a in use;

FIG. 2c shows a schematic circuit diagram illustrating the electronic circuitry forming part of the hair styling device shown in FIG. 2a;

FIG. 3 shows a schematic overview of a heater assembly that is used in the hair styling device shown in FIG. 2a;

FIG. 4 shows a schematic illustration of layers forming part of the heater assembly shown in FIG. 3;

FIG. 5a illustrates the dimensions of an aluminium substrate layer forming part of the heater assembly shown in FIG. 3;

FIG. 5b is a transverse cross-section through the aluminium substrate layer;

FIG. 6 shows a PSU track and a battery track formed from conductor layers of the heater assembly;

FIG. 7 shows the conductors of a PSU track layer forming part of the heater assembly;

FIG. 8 shows the conductors of a battery track layer forming part of the heater assembly;

FIG. 9 shows a varying width of the PSU track in a generally central region of the PSU track layer;

FIG. 10 shows a varying width of the PSU track in a region towards an edge of the PSU track layer;

FIG. 11a shows a varying width of the battery track in a region towards an edge of the battery track layer;

FIG. 11b shows a varying width of the battery track in a generally central region of the battery track layer;

FIG. 12 shows an end region of the battery track layer;

FIGS. 13a and 13b show reinforcing connection pads and the corresponding areas of the battery track layer;

FIG. 14a is a perspective view of the heater assembly showing electrical connections to the PSU track and to the battery track of the heater assembly shown in FIG. 3;

FIGS. 14b and 14c show a ribbon bond in a ‘tight’ configuration and a ‘looped’ configuration, respectively;

FIG. 14d schematically illustrates a pair of ribbons bonded to a connection pad;

FIG. 14e schematically illustrates a single ribbon bonded at multiple points to a connection pad;

FIG. 15 shows a transverse cross section of a mounting assembly including a mounting clip that allows the heater assembly to be mounted within an arm of the hair styling device;

FIG. 16 is a perspective view of the heater assembly and the mounting assembly shown in FIG. 15;

FIG. 17 shows an alternative configuration of the mounting clip;

FIG. 18 shows an overview of a further heater assembly;

FIG. 19 shows an exploded view of the heater assembly;

FIG. 20 illustrates a flow of current through the heater assembly;

FIG. 21 illustrates a voltage breakdown test applied to the heater assembly;

FIG. 22 shows a further modified version of the heater assembly;

FIG. 23 shows a modified version of the heater assembly of FIG. 4;

FIG. 24 shows an overview of a further device in which a heater assembly could be used; and

FIG. 25 shows a part of a device comprising a curved substrate for the heater.

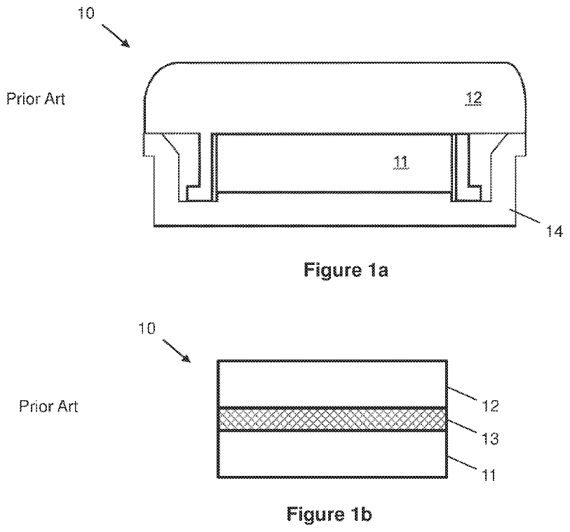

In the figures, like elements are indicated by like reference numerals throughout.

### DETAILED DESCRIPTION OF PREFERRED EMBODIMENTS

The present embodiments represent the best ways known to the applicant of putting the invention into practice. However, they are not the only ways in which this can be achieved.

### Overview of Hair Styling Device

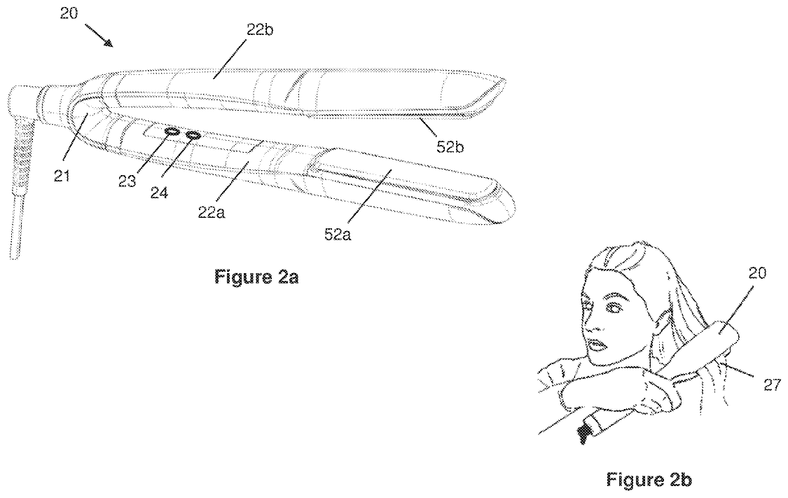

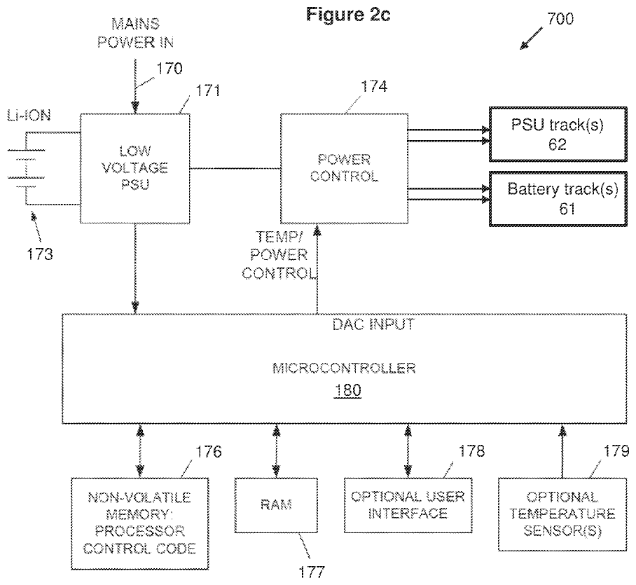

FIG. 2a is a perspective overview of a hair styling device 20. The device 20 is operable to style hair of a user, as illustrated in FIG. 2b. The styling process may be, for example, to straighten the hair (if necessary, preceded or succeeded by the application of styling products such as mousse, gel, wax, hairspray, etc.). If the user's hair is wet or damp, the device 20 also provides a drying effect. FIG. 2b illustrates the device 20 when in use to style hair 27. As illustrated in FIG. 2b, the device 20 is handheld and portable.

The device 20 comprises a pair of arms 22 connected by a hinge 21. The arms 22 are moveable between an open configuration, as illustrated in FIG. 2a, for receiving hair between the arms and a closed configuration in which the arms 22 are brought together to apply pressure to the hair of the user between two hair-contacting surfaces 52a and 52b. A control button or switch 24 may be provided on the device 20, to enable it to be turned on or off, together with an indicator light 23 to show whether the power is on. A sound can also be played by a sound generator (not illustrated) when the device 20 is switched on and ready to use. The operating temperature of the hair-contacting surfaces 52 may be, for example, between 140° C. and 190° C., typically about 185° C.

### Electronics Overview

FIG. 2c shows a block diagram of a power/control system 700 for the hair styling device 20.

The system comprises a low voltage power supply 171 deriving power from a battery 173 (for example, a 7.2 V battery comprising two 3.6 V cells, although 3 or more cells may alternatively be provided) and/or a mains power supply input 170, which can be used to charge the battery 173. Power from power supply 171 is provided to a power control module 174, which in turn powers one or more PSU tracks 62 and one or more battery tracks 61. The PSU tracks 62 and the battery tracks 61 (described in more detail below) are provided in heater assemblies of the device 20, for heating the hair contacting surface 52a and 52b. Power from power supply 171 is also provided to a microcontroller/control means 180 coupled to non-volatile memory 176 storing processor control code for a temperature control algorithm, and to RAM 177. The skilled person will appreciate that any of a wide range of different control algorithms may be employed including, but not limited to, on-off control and proportional control. Optionally the control loop may include a feed-forward element responsive to a further input parameter relating to the hair styling device 20, for example to use the operation of the device 20 to improve the temperature control. An optional user interface 178 is also coupled to microcontroller 180, for example to provide one or more user controls and/or output indications such as a light or audible alert. The output(s) may be employed to indicate, for example, when the temperature of the hair contacting surfaces 52 has reached a desired operating temperature, for example in a region between 140° C. and 190° C., typically about 185° C.

Microcontroller 180 is also coupled to one or more optional temperature sensors such as thermistors 179.

Each of the PSU track 62 and the battery track 61 may be provided with a separate control loop controlled by the temperature sensed by a respective thermistor 179.

A main PCB is provided within the housing of one of the arms 22 of the device (not shown in the figure). The main PCB includes the power control 174 circuitry.

When the device 20 is plugged in to the mains electricity, the device 20 may operate in a corded mode whilst simultaneously charging the battery 173. In this mode, only the PSU track 62 may be used to heat the hair contacting surfaces 52. Advantageously, therefore, the user need not wait for the battery 173 that powers the battery track 61 to recharge before the user can begin styling hair using the device 20. When the battery 173 is charged, it is also possible to power the PSU tracks 62 and the battery tracks 61 at the same time.

### Heater Assembly

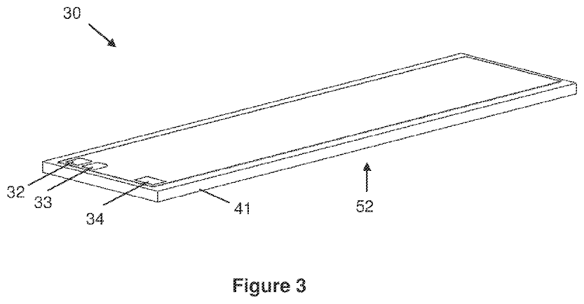

FIG. 3 shows a schematic overview of an elongate heater assembly 30 forming part of the hair styling device 20 illustrated in FIG. 2a. Two heater assemblies 30 are typically provided, one for each arm 22. The lower surface (not shown) of the two heater assemblies 30 form the hair contacting surfaces 52a and 52b shown in FIG. 2a. As will be described in more detail below, the heater assembly includes an elongate aluminium substrate layer 41, a power supply unit (PSU) connection pad 32, a battery connection pad 33 and a common ground pad 34. The connection pads 32 to 34 allow conductor tracks on the heater assembly 30 to be electrically connected to the power control circuitry 174 shown in FIG. 2c. As will be described in more detail later, the PSU connection pad 32 is for connection of a PSU track 62 to a power source, for flow of current between the PSU connection pad 32 and the common ground pad 34. Similarly, the battery connection pad 33 allows power to be supplied to a battery track 61 for flow of current between the battery connection pad 33 and the common ground pad 34. As discussed in more detail later, the PSU connection pad 32, the battery connection pad 33 and the common ground pad 34 are all formed of a material used to print a battery track layer 45, and each of the connection pads is reinforced by an additional layer of material of a connection pad reinforcement layer 46.

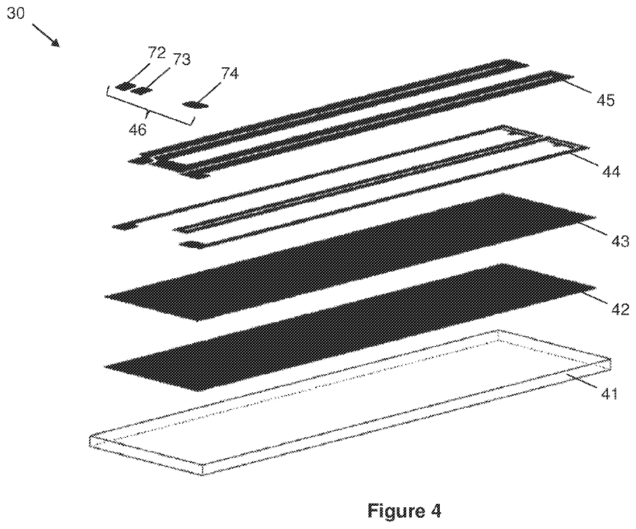

FIG. 4 shows a schematic and exploded illustration of different layers of the heater assembly 30 according to this embodiment. The heater assembly 30 comprises a plurality of thick film printed conductor layers, including a PSU track layer 44, a battery track layer 45 and a conduction pad reinforcement layer 46, which together define heater elements (s) that generate heat when current flows through them. As shown in FIG. 4, first and second dielectric layers 42 and 43 are provided between the conductive layers 44 to 46 and the aluminium substrate 41. This ensures electrical isolation between the current carrying layers 44 to 46 and the substrate 41 which the user can touch. A screen printing process is used to bond the layers to the layer below and ultimately to the aluminium substrate 41. The screen printing process creates a highly efficient thermal bond between the layers and the aluminium substrate 41 whilst beneficially providing a heater assembly 30 that has a particularly low thermal mass which increases the efficiency and decreases the thermal lag of the hair styling device 20. Therefore, the hair styling device 20 can heat up quicker and more efficiently than what can be achieved using the prior art type of heater assembly. Moreover, the energy required to maintain the hair styling surface 52 at the operating temperature is reduced. In other words, the in-use efficiency of the device is improved. The screen printed layers 42 to 46 have a typical total thickness of approximately 100 μm which is approximately 10 times thinner than the heater elements that are commonly used in currently commercialised flat plate hair stylers (having a thickness of approximately 1 mm). The thermal mass of the heater assembly 30 including the aluminium substrate 41 and the printed layers is approximately 6.65 J/K, and the thermal mass of a mounting clip used to retain the heater assembly 30 in an arm of the device (described in more detail later) is approximately 1.99 J/K. The thermal mass of the heater assembly 30 and the associated mounting clip is therefore significantly lower than the thermal mass of the heater arrangement of a conventional flat plate hair styler (typically greater than 50 J/K).

Beneficially, the heat transfer from the printed conductor layers 44 to 46 to the hair contacting surface of the aluminium substrate layer 41 is highly efficient due to the direct thermal contact between the printed layers and the substrate 41. Heat energy is transferred to the substrate 41 (the hair-contacting surface) almost immediately after the heat is generated by current flowing through the screen-printed conductor layers 44 to 46. Moreover, the direct thermal connection between the printed layers and the aluminium substrate 31 removes the need for any additional thermal interface material (for example, thermal paste) between the layers and the substrate 41. The improved thermal efficiency also increases the run-time of the device when the device operates on battery power. Beneficially, in use, the heater assembly 30 of the present disclosure requires approximately 5 W less power per hair styling surface (operating at approximately 60 W for a pair of hair styling surfaces) to maintain the hair styling surface 52 at the operating temperature, compared to a conventional heater assembly operating according to the same temperature profile. Moreover, the heater assembly 30 of the present disclosure only requires approximately 50% of the power required by conventional heater assemblies to heat the hair styling surface to the operating temperature in the same amount of time.

Advantageously, because the thermal efficiency of the heater assembly 30 is much greater than the prior art heater assemblies used in commercial flat plate stylers and because the thermal mass of the heater assembly 30 is relatively low, the hair styling device 20 may be configured to operate at safe-extra-low voltages (for example, less than 42 V). That is the mains derived voltage generated by the low voltage PSU 171 can be kept below 42 Volts. Whilst in practice this limits the operating power to about 150 W, the inventors have found that because of the thermal efficiency of the heater assembly 30, this can be enough power to heat the user's hair sufficiently to allow styling. If additional heat is required, the power control unit 174 can simultaneously connect the AC derived supply voltage to the PSU track(s) 62 and the battery voltage to the battery track(s)—so that both heater elements heat the aluminium substrate 41 at the same time which can provide over 200 W of heating power. The use of such safe-extra-low voltages also enables the use of contact temperature measurement sensors and the use of metal surfaces on the styler housing, which could otherwise not be used due to the possibility of user electric shock (and high voltage safety regulations). The use of metal surfaces on the styler housing can also improve the hair-styling performance and overall thermal properties of the device 20, due to improved heat dissipation properties compared to, for example, a plastic casing.

Advantageously, the heater assembly 30 of the present disclosure is particularly compact. The heater assembly 30 can therefore be more easily packaged into the housing of the device 20, reducing the design constraints on the housing and reducing the overall size of the hair styling device 20. The reduced size of the hair styling device 20 enables the user to more easily hold the device and more easily style hair. Alternatively, or additionally, the additional space created by the compact heater assembly 30 may be used to provide additional insulation between the heater assembly 30 and the main housing of the hair styling device 20. This reduces the thermal transfer to the housing, increasing the efficiency of the device and the comfort of the user.

### Heater Assembly Configuration

As described above and as illustrated in FIG. 4, the elongate heater assembly 30 comprises a plurality of screen printed layers 42 to 46 and an aluminium substrate layer 41. In more detail, the heater assembly 30 illustrated in FIG. 4 comprises an aluminium substrate layer 41, a first dielectric layer 42, a second dielectric layer 43, a PSU track layer 44, a battery track layer 45 and a connection pad reinforcement layer 46.

The heater assembly 30 may also comprise one or more additional dielectric layer(s) on the upper surface of the heater assembly 30 illustrated in FIG. 4, furthest from the aluminium substrate layer 41, though this need not necessarily be provided. Alternatively, a layer of Kapton (RTM) tape or other electrically insulating material may be provided.

A detailed description will now be given of these different layers of the heater assembly 30 that is used in this exemplary embodiment. Clearly, the dimensions given are exemplary only and other dimensions could of course be used.

### Aluminium Substrate Layer

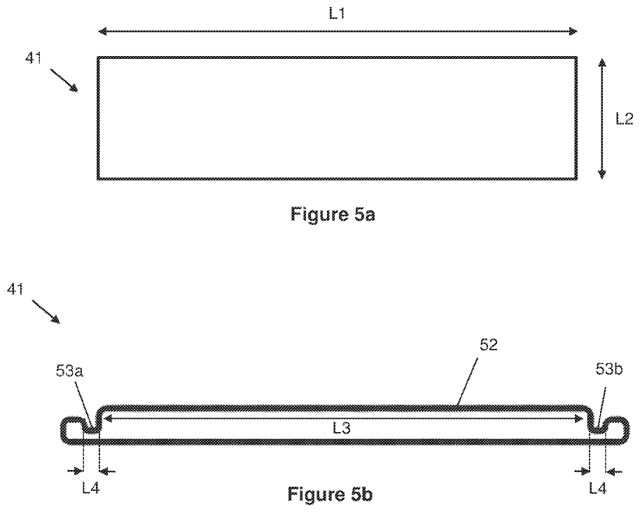

As illustrated in FIGS. 5a and 5b, the elongate aluminium substrate layer 41 used in this exemplary embodiment has a length L1 of 80 mm and a width L2 of 25.2 mm. The thickness of the aluminium substrate layer is 1.5 mm. The material composition of the aluminium substrate layer 41 is described in detail below.

As illustrated in FIG. 5b, the aluminium substrate layer 41 has a hair contacting surface 52 for engaging with hair of the user to heat and style the hair. The transverse width L3 of the hair contacting surface 52 is 22 mm. As described in more detail below, two longitudinal channels 53a and 53b (extending along the length L1 of the aluminium substrate 41) are provided either side of the hair contacting surface 52 for engaging with a mounting clip. The width L4 of each of the longitudinal channels 53 is 0.65 mm.

### Dielectric Layers

The first dielectric layer 42 and second dielectric layer 43 are electrically insulating layers that are provided between the conductive heater track layers (the PSU track layer 44, the battery track layer 45 and the connection pad reinforcement layer 46) and the aluminium substrate 41, providing electrical insulation between these current carrying heater tracks and the aluminium substrate 41 which comes into contact with the user's hair. Typically, the dielectric layers are not patterned and each form a substantially uniform layer of material. The dielectric material used to form the dielectric layers may be a silica (SiO₂) based material. The length of the first dielectric layer 42 is 78 mm and the width of the first dielectric layer 42 is 18.3 mm. The thickness of the first dielectric layer 42 is between 0.01 mm and 0.025 mm, for example 0.023 mm. The length of the second dielectric layer 43 is 77.9 mm and the width of the second dielectric layer 43 is 18.2 mm. The thickness of the second dielectric layer 43 is also between 0.01 mm and 0.025 mm, for example 0.023 mm.

The first dielectric layer 42 is printed directly onto the aluminium substrate 41, which results in highly efficient thermal transfer between the first dielectric layer 42 and the aluminium substrate layer 41. The second dielectric layer 43 is printed directly onto the first dielectric layer 43 to increase the electrical insulation between the heater tracks and the aluminium substrate 41.

It will be appreciated that the electrically insulating properties of the dielectric layers depends on both the material composition of the layers and on the thickness of the layers. The composition and thickness of the layers in the present example is described in detail below. However, it will be appreciated that any other suitable material or thickness may be used to form the dielectric layers. For example, an anodic oxide layer (up to 50 microns in thickness) could be fabricated directly onto the aluminium substrate 41. Plasma electrolytic oxidation (PEO), also known as micro arc oxidation (MAO), can be used to fabricate an oxide layer which can provide the necessary dielectric properties. This type of coating has several advantages. For example, there is no adhesion or CTE mismatch issue, good consistency in layer thickness, a robust coating process with good control, excellent repeatability, and excellent dielectric properties. Other high temperature and electrically insulating materials such as polyimide could also be used.

In the heater assembly 30 illustrated in FIG. 4, two layers of dielectric material are provided between the heater tracks and the aluminium substrate 41 in order to provide sufficient electrical insulation, due to limitations in the maximum and minimum thicknesses of dielectric layers that can be formed using the screen printing process. Providing two dielectric layers between the heater tracks and the aluminium substrate 41 allows for reliable and simpler screen printing of the dielectric layers whilst providing sufficient dielectric material to meet the electrical insulation requirements for safe operation of the device. However, it will be appreciated that the number of dielectric layers between the heater tracks and the aluminium substrate 41 need not necessarily be two. For example, three or more layers of electrically insulating material may be provided between the heater tracks and the aluminium substrate 41. However, there is a problem that due to the differing thermal properties of each layer of the heater assembly 30, warping or ‘bowing’ of the assembly may occur as the temperature of the device increases (for example, during the high temperatures experienced during the manufacture of the heater assembly). The thickness of the dielectric layers is an important parameter with respect to ensuring that sufficient electrical insulation is provided between the aluminium substrate 41 and the heater tracks, whilst reducing the propensity for warping of the heater assembly 30. The material used to form the dielectric layers may have a very different coefficient of thermal expansion (CTE) compared to that of the aluminium substrate layer 41. Therefore, when the dielectric material is fired for curing on the aluminium substrate 41, it expands at a different rate than the aluminium, potentially resulting in warping of the heater assembly 30. The risk of warping can be reduced by reducing the total thickness of the dielectric material. However, the dielectric layer must be thick enough to ensure sufficient electrical insulation between the heater tracks and the aluminium substrate—as the thickness of the dielectric material is reduced the breakdown voltage of the dielectric layer(s) is also reduced. Whilst the risk of warping could also be reduced by increasing the thickness of the aluminium substrate, this would increase the thermal mass, decreasing the efficiency of the device. Therefore, the thickness of (and number of layers of) the dielectric material has been carefully selected to reduce the propensity for warping, whilst ensuring sufficient electrical insulation is provided between the heater tracks and the aluminium substrate 41 (for example, by providing a breakdown voltage of at least 50 V).

Increasing the number of dielectric layers may increase the propensity for undesirable warping of the heater assembly 30. Therefore, in the heater assembly 30 illustrated in FIG. 4, the provision of two layers is preferred, since it provides sufficient electrical insulation whilst having a reduced propensity for warping compared to when three or more layers of dielectric material are provided. In alternative embodiments a single dielectric layer may be provided instead or where a non-conducting substrate is provided no dielectric layer may be provided.

### PSU Track and Battery Track

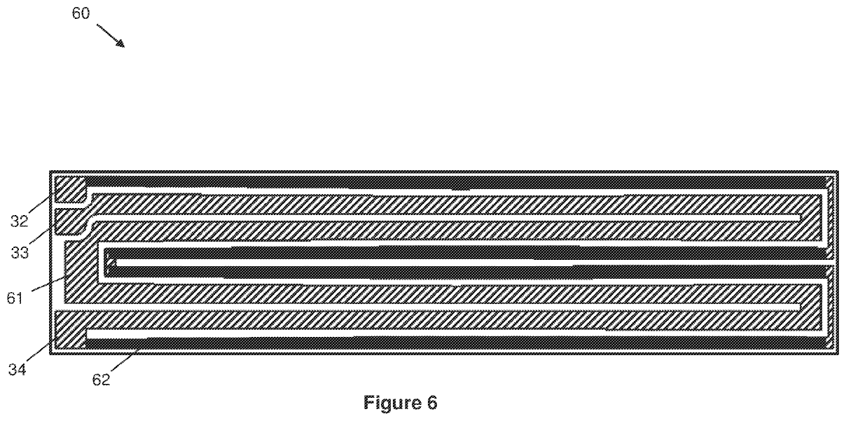

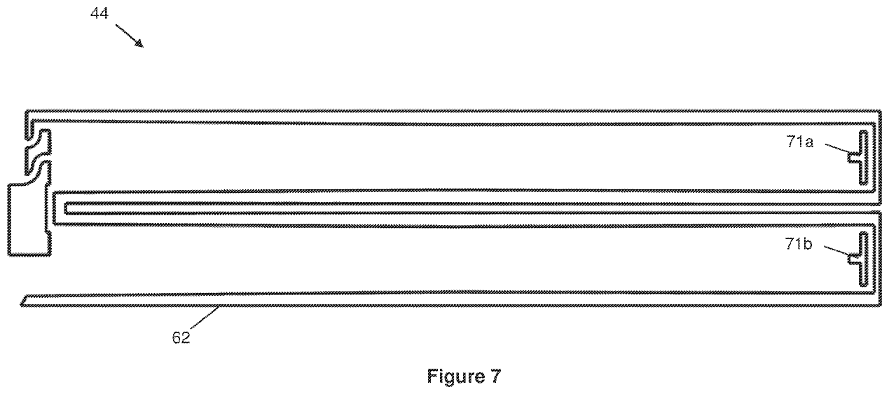

As illustrated in FIGS. 4 and 6, two screen printed resistive heater tracks (the battery track 61 and the PSU track 62) are provided. The battery track 61 may be used (but is not restricted to use) when the hair styling device 20 operates in a cordless mode and is powered by the battery 173. The PSU track 62 is used when the low voltage PSU 171 provides power derived from the mains supply input 170. It will be appreciated, therefore, that providing a separate PSU track 62 and battery track 61 allows the device 20 to operate in either corded or cordless modes of operation. When the battery 173 of the device 20 is fully drained, the device 20 can be operated using the PSU track 62. Beneficially, therefore, after the device 20 is connected to mains electricity, the user need not wait until the battery recharges sufficiently to use the hair styler as they can instead operate the hair styling device 20 using the PSU track 62 only. Moreover, since the heating can be shared between the PSU track 62 and the battery track 61, the load on the battery 173 is reduced, and the lifetime of the battery is beneficially increased. As discussed above, heating can be achieved using both the PSU track 62 and the battery track 61 at the same time.

A presently preferred configuration of the PSU track layer 44 and battery track layer 45 will now be described with reference to FIG. 6, which shows an overlay of these two layers showing the relative arrangement of the PSU track 62 and the battery track 61. As illustrated in FIG. 6, the PSU track 62 follows a meandering or serpentine path from the PSU connection pad 32 to the common ground pad 34, to form an electrical connection between the PSU connection pad 32 and the common ground pad 34. Similarly, the battery track 61 also follows a meandering or serpentine path from the battery connection pad 33 to the common ground pad 34, to form an electrical connection between the battery connection pad 33 and the common ground pad 34. (Separate ground connection pads for the two tracks could be provided if desired.) The material of the PSU track layer 44 is indicated by the solid black region. The material of the battery track layer 45 is indicated by the diagonally shaded region. As shown in FIG. 6, the meandering or serpentine paths taken by the tracks 61 and 62 interleave with each other in order to maximise the surface area taken up by the tracks 61 and 62. This maximises the amount of conductive material forming the tracks 61 and 62, which in turn minimises the electrical resistance of the tracks 61 and 62 which maximises the electrical current that will flow through the tracks 61 and 62 for a given applied voltage. It will be appreciated that as an electrical current flows through the PSU track 62 and the battery track 61 towards the common ground pad 34, heat is generated in each of the tracks. This heat is transferred to the aluminium substrate 41 for subsequent transfer to the hair being styled via the hair contacting surface 52.

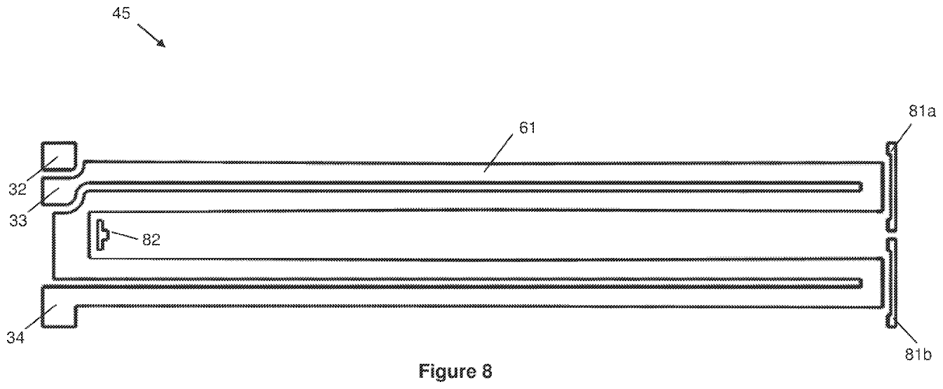

FIGS. 7 and 8 are schematic illustrations of the PSU track layer 44 and the battery track layer 45, respectively. As illustrated in FIGS. 6 to 8, the PSU track 62 is predominantly formed by the conductive material of the PSU track layer 44. Similarly, the battery track 61 is predominantly formed by the conductive material of the battery track layer 45. However, it will be appreciated that the material printed to form the battery track layer 45 is not only used to form the battery track 61, and the material printed to form the PSU track layer 44 is not merely used to form the PSU track 62. The battery track layer also includes the PSU connection pad 32, the battery track connection pad 33 and the common ground pad 34. In other words, the terms ‘battery track layer’ and ‘PSU track layer’ are merely convenient labels used to describe the layers of printed material. For example, the PSU track layer 44 also includes two battery track reinforcing portions 71a and 71b for improving the heat distribution in the heater assembly 30, in use. Similarly, the battery track layer 45 includes a set of first PSU track reinforcing portions 81a and 81b, and a second PSU track reinforcing portion 82, for improving the heat distribution in the heater assembly 30, in use. The T-shaped battery track reinforcing portions 71a and 71b, and the T-shaped PSU track reinforcing portions 81a and 81b, help to reduce the occurrence of hot-spots due to bends in the PSU track 62 and the battery track 61. Corners or bends in the heater tracks may cause a local increase in resistance, increasing the local power output and the risk of hot-spots occurring. The battery track reinforcing portions 71a and 71b, and the PSU track reinforcing portions 81a and 81b, mitigate this effect by increasing the local thickness of the heater tracks, thereby decreasing the local resistance.

In the present example, the PSU track layer 44 has a thickness of 0.015 mm and the battery track layer 45 also has a thickness of 0.015 mm. Whilst the thickness of the tracks is an important parameter when considering the electrical conductivity and hence resistance of the tracks, there is a limit on the thickness of track that can be reliably and efficiently formed using a screen printing process. Therefore, the material composition of the PSU track 62 and the battery track 61 is important for achieving the desired electrical conductivity/resistance. In the present example, the PSU track 62 is formed from a conductive material comprising a relatively large fraction of silver. The battery track 61 is similarly formed from a conductive material comprising a relatively large fraction of silver (in this example, at least 90% silver). More specifically, the battery track 61 and the PSU track 62 are formed from materials comprising glass and large fraction of silver, enabling particularly low resistances of the heater tracks to be achieved (for example, a 0.4Ω resistance for the battery track, that enables operation using a 2 cell battery of approximately 8 V—the use of 2 cells enables a particularly compact and low weight hair styling device). Whilst the resistance of the tracks could also be reduced by increasing the track thickness, this would require printing additional track material (possibly in the form of additional layers), increasing the manufacturing cost and complexity.

Alternatively, the PSU track 62 and battery track 61 may be formed of any other suitable conductive material (for example, copper, gold, platinum, titanium graphite, or a silver-palladium alloy) that can be deposited onto the insulating dielectric layer(s) to form the heater tracks. However, whilst use of a silver-palladium alloy may provide improved stability (reduced migration of free silver ions towards the substrate through the dielectric layers), the use of palladium results in an undesirable increase in the unit resistance of the material.

In the present example, the migration of the silver-based material through the dielectric layers towards the substrate (which may cause short circuits over time) is mitigated by providing sufficient dielectric insulation between the heater tracks and the aluminium substrate (and by providing a sufficiently smooth surface of the aluminium substrate) to prevent electrical breakdown. However, increasing the thickness of the dielectric layers increases the propensity for warping of the heater assembly (and also undesirably increases the thermal mass of the heater assembly). Therefore, the particularly advantageous thickness of the dielectric layers in the present example has been selected to provide a balance between providing sufficient electrical insulation to allow the use of the silver-based material to form the heater tracks, whilst also reducing the risk of warping.

As will be described in more detail below, the configuration of the PSU track 62 and the battery track 61 provide a particularly uniform power output across the surface of the heater assembly 30 (which generates a corresponding uniform temperature distribution on the hair contacting surface 52), whilst maximising the width of the battery track 61 to make efficient use of the available space. Moreover, the arrangement of the tracks results in a relatively uniform power output across the surface of the heater assembly even when one of the heater tracks is powered alone (i.e. when only one of the PSU track 62 or the battery track 61 is in operation). As can be seen from FIGS. 6 to 8, the battery track 61 and the PSU track 62 share the available space or footprint. As the battery voltage is lower than the PSU voltage, it is preferrable that the resistance of the battery track 61 is lower than the resistance of the PSU track 62 to maximise the current and therefore heating that the battery track 61 can provide. In practice that means that the conductive tracks forming the battery track 61 are wider than those forming the PSU track 62, which means that the battery tack 61 takes up more of the available space.

As can be seen from FIGS. 6 to 8, the conductive tracks that make up the PSU track 62 have double thickness in the end regions. This means that the end regions of the PSU track 62 will have lower resistance and will therefore produce less heat than a central region of the PSU track 62 (assuming the track has a constant width along its length). In order to compensate for this, the width of the PSU track 61 preferably increases along its length away from the end regions. The inventors have found that this arrangement helps to make the heat output from the PSU track 62 more uniform over the heater assembly 30.

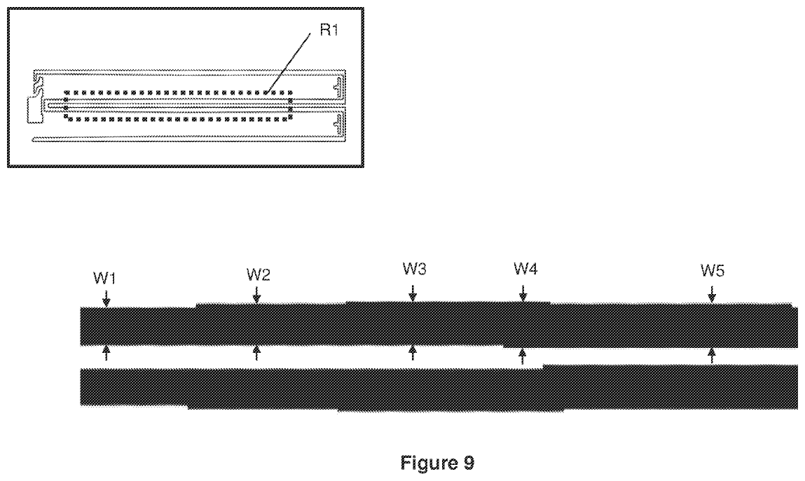

FIG. 9 shows a magnified view of the PSU track 62 in a generally central region R1 of the PSU track layer 44 indicated by the dashed rectangle in the inset. As can be seen in the figure, the PSU track 62 has a non-constant width along the length of the heater assembly 30 (i.e. in the longitudinal direction). In more detail, the PSU track 62 has a width W1 towards the end adjacent to the connection pads (i.e. the left-hand side of FIG. 9). Widths W2 to W5 are also shown. In this example, the widths of the PSU track 62 are configured such that: W1<W2<W3<W4; and W4>W5. Beneficially, the width of the PSU track 62 increases towards the midpoint of the length along the heater assembly, away from the connection pad end. In other words, the PSU track 62 has a tapered shape in the longitudinal direction. The width of the PSU track 62 is approximately 0.85 mm in the region adjacent the PSU connection pad 32, and increases to a value of 1.2 mm towards the approximate midpoint along the length of the heater assembly. From the approximately midpoint of the heater assembly 30 along the longitudinal direction, the width of the PSU track 62 decreases to a value of 1.1 mm towards the end of the PSU track layer 44 that is furthest from the PSU connection pad 32.

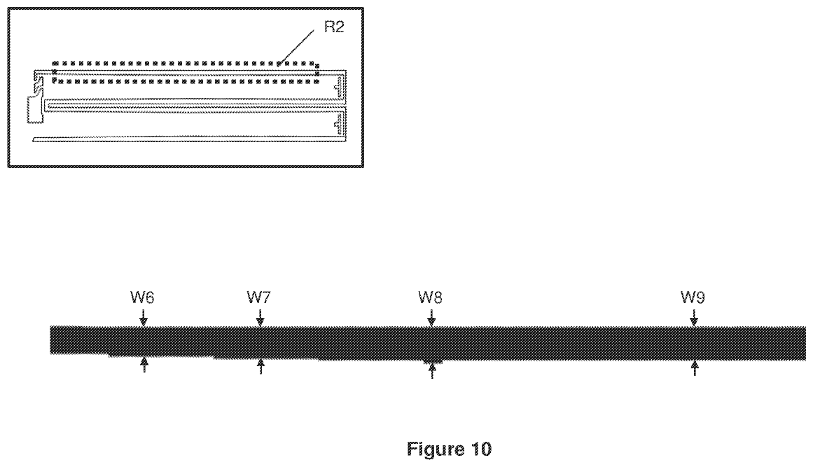

FIG. 10 shows a corresponding view of the PSU track 62 in a generally peripheral side region R2 of the PSU track layer 44, indicated by the dashed rectangle in the inset. Similar to the portion of the PSU track 62 illustrated in FIG. 9, the width of the PSU track 62 increases towards the midpoint of the length along the heater assembly 30, away from the connection pad end. In more detail, in this example, the widths W6 to W9 are configured such that W6<W7<W8; and W9<W8. Although not shown in the Figures, the track width in the lower peripheral side region of the PSU track 62 will also taper in the same way.

As the PSU track 62 and the battery track 61 are packed tightly together with a minimum spacing between the tracks, as the PSU track gets thicker the battery track preferably gets thinner in order to maintain the desired minimum spacing between the tracks.

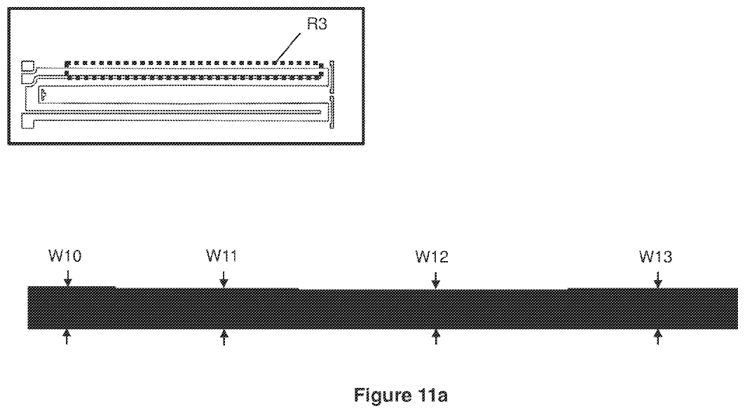

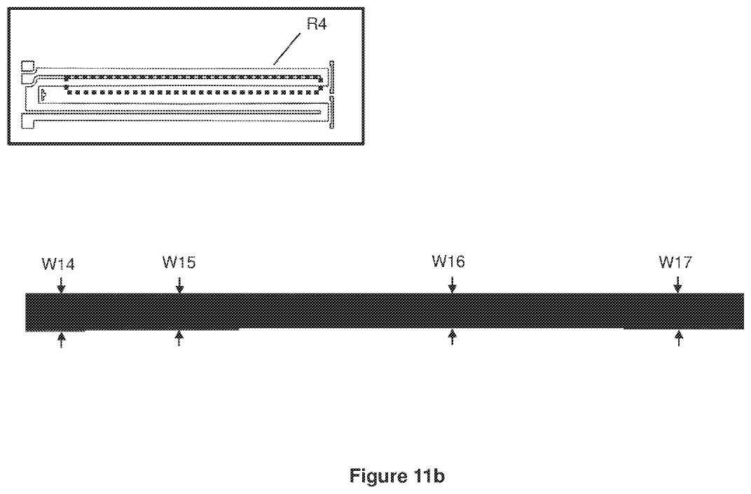

FIG. 11a shows a more detailed view of the battery track 61 in a generally peripheral side region R3 of the battery track layer 45, indicated by the dashed rectangle in the inset. As can be seen in the figure, the battery track 61 has a non-constant width along the length of the heater assembly 30 (i.e. in the longitudinal direction). In more detail, the battery track 61 has a width W10 at the end adjacent to the connection pads (i.e. the left-hand side of FIG. 11a). Further widths W11 to W13 are also shown. In this example, the widths of the battery track 62 are configured such that: W10>W11>W12; and W12<W13. In this example, the width of the battery track 61 decreases towards the midpoint of the length along the heater assembly 30. In other words, the battery track 61 has a tapered shape so that in the regions in which the PSU track 62 is relatively wide, the battery track 61 is relatively narrow, and in the regions in which the PSU track 62 is relatively narrow the battery track 61 is relatively wide.

FIG. 11b shows a corresponding view of the battery track 61 in a generally central region R4 of the battery track layer 45 indicated by the dashed rectangle in the inset. As can be seen in the figure, the battery track 61 has a non-constant width along the length of the heater assembly 30 (i.e. in the longitudinal direction). In more detail, the battery track 61 has a width W14 at the end adjacent to the connection pads (i.e. the left-hand side of FIG. 11b). Further widths W15 to W17 are also shown. In this example, the widths of the battery track 62 are configured such that: W14>W15>W16; and W16<W17. In this example, the width of the battery track 61 decreases towards the midpoint of the length along the heater assembly 30. In other words, the battery track 61 has a tapered shape so that in the regions in which the PSU track 62 is relatively wide, the battery track 61 is relatively narrow, and in the regions in which the PSU track 62 is relatively narrow the battery track 61 is relatively wide.

Due to the lower power output from the battery track 61 compared to the PSU track 62, there is less need for the width of the battery track 61 to be configured to reduce excessive heat build-up at the connection pad end of the heater assembly 30. Therefore, the battery track 61 can instead be configured primarily to make more efficient use of the available space, by maintaining a minimum spacing between the battery track 61 and the PSU track 62. In the present example a minimum separation of approximately 0.7 mm is maintained between the battery track 61 and the PSU track 62 due to electrical operation requirements (e.g. to ensure adequate electrical isolation between the battery track 61 and the PSU track 62).

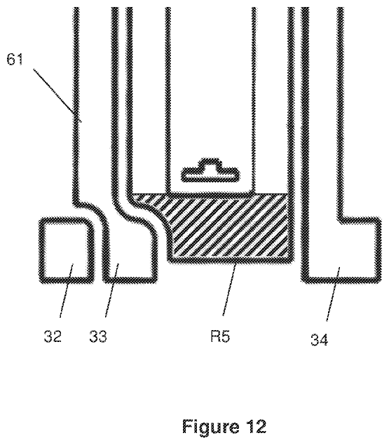

FIG. 12 shows an end region of the battery track layer 45. The diagonally shaded region R5 is a region of the battery track 61 that is located generally between the battery connection pad 33 and the common ground pad 34, towards the end of the heater assembly. As illustrated in the figure, the width of the battery track 61 is particularly large in this region R5. Beneficially, the increased width of the battery track in this region locally reduces the resistance of the battery track 61, such that less power (heat) is dissipated in this region. Beneficially, the reduced heat output from the battery track 61 in this region reduces the thermal stress on the connection pads 32 to 34, reducing the risk of failure of the electrical connections to the heater tracks 61 and 62. As described in more detail later, this is particularly advantageous since electrical connections to thick film printed layers are relatively difficult to form, relatively fragile and prone to failure.

### Connection Reinforcement Layer

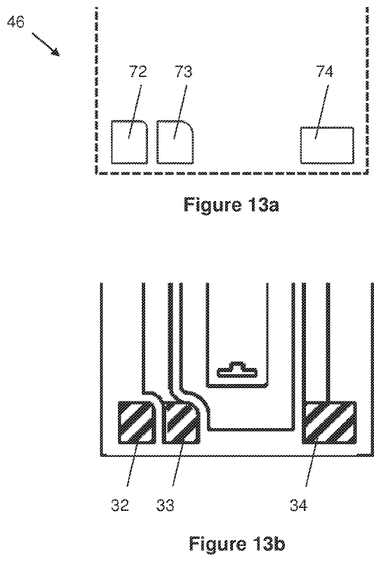

FIG. 13a shows a more detailed view of the connection pad reinforcement layer 46. As illustrated in the figure, the connection pad reinforcement layer 46 comprises a PSU connection reinforcement pad 72, a battery connection reinforcement pad 73, and a common ground connection reinforcement pad 74. Each of the connection reinforcement pads is printed on top of the corresponding one of the PSU connection pad 32, battery connection pad 33 and common ground pad 34 of the battery track layer 45, illustrated with diagonal shading in FIG. 13b. The reinforcing pads are formed of the same material as used to form the battery track 61 and, as described in detail below, improves the strength and reliability of the electrical connections to the tracks 61 and 62 of the heater assembly 30. The connection pad reinforcement layer may be between 0.010 mm and 0.020 mm in thickness, for example 0.015 mm. The total thickness of the battery connection pads 33, including the connection pad reinforcement layer, may be between 0.025 mm and 0.035 mm, for example 0.030 mm.

In the heater assembly 30 illustrated in FIG. 4 a single connection reinforcement layer 46 is shown. Alternatively, a plurality of connection reinforcement layers 46 may be provided. In a particularly advantageous example, two connection reinforcement layers 46 are provided. Beneficially, providing a second connection reinforcement layer 46 on top of a first connection reinforcement layer 46 was found to improve the metallurgical bonding between a ribbon and the connection pads in a ribbon bonding process, and reduces the risk of bond failure during the bonding process.

The heater assembly 30 generates heat by passing an electrical current along the PSU track 62, the battery track 61, or both tracks simultaneously. The resistance of each track is an important property for achieving the desired level of heat output from the heater for the given operating voltages. The resistance of a heater track is determined by the material composition of the heater track (in this example, the material of each heater track comprises a relatively large fraction of silver) and the physical dimensions of the heater track. Beneficially, the resistance of the battery track 61 of the present example is particularly low, reducing the number of cells of the battery 173 required to power the battery track 61 whilst achieving a given heating power output. In this example the battery track 61 has a resistance of approximately 0.42. When a pair of heater assemblies 30 are provided in the device, this allows a total heating power of up to approximately 274 W (approximately 137 W per heater) to be provided using a total battery voltage of 7.4 Volts.

As mentioned above, the thickness of an individual layer of heater track material that can be formed is restricted due to limitations of the screen printing process. Whilst additional layers of track material could be printed to increase the track thickness (and therefore decrease the resistance of the track), this results in increased manufacturing complexity and cost, and may increase the propensity for undesirable warping or failure of the heater assembly 30. Therefore, the width of the tracks is an important parameter in determining the resistance at a particular point along the track. The spatial configurations of the tracks of the present example have been carefully configured to achieve more uniform heat distribution across the hair contacting surface 52. As described above, the width of the tracks varies along the length of the heater assembly to provide a more uniform heat distribution.

### Method of Manufacture of the Heater Assembly

A method of manufacturing the heater assembly 30 illustrated in FIG. 4 will now be described.

### Aluminium Substrate Layer

The heater assembly 30 is formed by screen printing thick film layers of material onto the aluminium substrate layer 41. Once each layer is printed, the assembly is heated (fired) to approximately 500 degrees C. to bond the printed layer to the substrate or the layer below. Therefore, the properties of the surface of the aluminium substrate layer 41 are important for reliably printing the other layers of the heater assembly 30, and for providing efficient thermal transfer between the aluminium substrate layer 41 and the fist dielectric layer 42.

Due to the different thermal properties of the layers that form the heater assembly 30, the heater assembly 30 has a propensity for warping when undergoing changes in temperature during the firing process discussed above. Therefore, it is desirable that the particular alloy used for the substrate layer 41 reduces the propensity for warping. Moreover, when the alloy has a reduced propensity for warping, this allows the thickness of the aluminium substrate layer 41 to be decreased, which beneficially further reduces the thermal mass of the heater assembly 30. As discussed above, a reduction in the thermal mass of the heater assembly 30 advantageously reduces the thermal lag between the user switching on the device 20 and the hair contacting surface 52 reaching the operating temperature for styling hair.

In a preferred embodiment the aluminium alloy 6063-T5 is used to form the aluminium substrate layer 41. A 1.5 mm thick layer of this alloy was found to remain particularly flat (i.e. this alloy has a low propensity for warping) when fired to a temperature of 580° C.—a temperature similar to those used to fire the printed layers during the construction of the heater assembly.

The aluminium alloy 6063-T5 may comprise, for example, 0.440 wt. % Si, 0.480 wt. % Mg, 0.170 wt. % Fe, 0.030 wt. % Mn, <0.01 wt. % Cu and 0.01 wt. % Ti. Alternatively, for example, the aluminium alloy 6063-T5 may comprise 0.441 wt. % Si, 0.443 wt. % Mg, 0.198 wt. % Fe, 0.037 wt. % Mn, 0.009 wt. % Cu, and 0.032 wt. % Ti.

The surface roughness of the aluminium substrate layer 41 is an important property of the heater assembly 30. When the aluminium substrate layer 41 is sufficiently smooth, the number of layers of dielectric material and their thickness can be reduced whilst maintaining sufficient electrical insulation between the PSU track 62 and the aluminium substrate 41 (and between the battery track 61 and the aluminium substrate 41). Reducing the number of dielectric layers reduces the manufacturing costs and reduces the propensity of the heater assembly 30 to warp. In a preferred embodiment, the roughness parameters for the surface of the aluminium substrate 41 that contacts the first dielectric layer 42 are given by: Ra≤0.2 μm; Rz≤1.4 μm; and Rmax≤1.4 μm, where Ra is the mean roughness (the arithmetic average of the absolute values of the roughness profile ordinates), Rz is the mean roughness depth (the arithmetic mean value of the single roughness depths of consecutive sampling lengths), and Rmax is the maximum roughness depth (the largest single roughness depth within the evaluation length).

Whilst in this example an aluminium substrate formed of the aluminium alloy 6063-T5 is used, it will be appreciated that any other suitable aluminium alloy may be used. Moreover, it will be appreciated that the substrate need not necessarily be formed of aluminium. For example, magnesium or a suitable magnesium-aluminium alloy may be used to form the substrate. Alternatively, for example, copper (or a suitable copper alloy) may be used to form the substrate. In a further alternative, described in more detail later, the substrate may be formed from an electrically insulating, but thermally conductive, material such as aluminium nitride or beryllium oxide.

### First Dielectric Layer

In the following description, the term ‘total heating time’ is used. The ‘total heating time’ is the total time taken to heat the material from room temperature to the peak temperature, and then to cool back to room temperature.

Before the material of the first dielectric layer 42 is deposited, the aluminium substrate 41 is heated to a temperature of 580° C. using a total heating time of between 35 to 40 minutes, including 5 to 7 minutes at the peak temperature.

The first dielectric layer 42 is then formed by screen printing the dielectric material directly onto the aluminium substrate 41 using a 200 mesh stainless steel screen to form a layer that is 78 mm long, 18 mm wide and 0.023 mm thick. After the material has been deposited, the heater assembly 30 is dried in a ventilated box furnace at 150° C. for 15 minutes. The heater assembly 30 is then fired in a ventilated box furnace at 570° C. for a total time of 35 minutes, including 5 to 7 minutes at the peak temperature.

### Second Dielectric Layer

After the first dielectric layer 42 has been formed, the second dielectric layer 43 is deposited. The second dielectric layer 43 is formed by screen printing the dielectric material directly onto the first dielectric layer 42 using a 200 mesh stainless steel screen to form a layer that is 77.9 mm long, 18.2 mm wide and 0.023 mm thick. The screen-printed dielectric material is then dried in a ventilated box furnace at 150° C. for 15 minutes, before being fired in a ventilated box furnace at 570° C. for a total time of 35 minutes, including 5 to 7 minutes at the peak temperature.

As described above, additional layers of dielectric material may be deposited at this stage, depending on the specific insulation requirements. However, each time a new layer is screen printed and fired, the chances that the heater assembly will fail increases. Therefore, minimizing the number of dielectric layers is desirable.

### PSU Heater Track Layer

After the second dielectric layer 43 has been formed, the PSU track layer 44 is deposited. The PSU track layer 44 is formed by screen-printing the PSU track material directly onto the second dielectric layer 33 to form a layer that is 0.015 mm thick.

The screen-printed material of the PSU track layer 44 is then dried in a ventilated box furnace at 150° C. for 15 minutes, before being fired in a ventilated box furnace at 550° C. for a total time of 35 minutes, including 5 to 7 minutes at the peak temperature.

### Battery Track Layer

After the PSU track layer 44 has been formed, the battery track layer 45 is deposited. The battery track layer 45 is formed by screen-printing the battery track material directly onto the PSU track layer 44 (and where there are gaps in the PSU track layer, the material of the battery track layer 45 is printed onto the surface of the second dielectric layer 43) to form a layer that is 0.015 mm thick.

The screen-printed material of the battery track layer 45 is then dried in a ventilated box furnace at 150° C. for 15 minutes, before being fired in a ventilated box furnace at 550° C. for a total time of 35 minutes, including 5 to 7 minutes at the peak temperature.

In a preferred embodiment, the material of the battery track 61 comprises a higher percentage of silver material than that of the PSU track 62. As a result, per unit volume, the battery track 61 material has a lower resistance compared to the PSU track 62 material, and enables a particularly low resistance (of approximately 0.4 Q) to be achieved for the path between the battery connection pad 33 and the common ground pad 34.

### Connection Pad Reinforcement Layer

After the battery track layer 45 has been formed, the connection pad reinforcement layer 46 is deposited. The connection pad reinforcement layer 46 is formed by screen printing battery track material directly onto the connection pads of the battery track layer 45 to form a layer that is between 0.010 mm and 0.020 mm thick (for example, 0.015 mm thick).

The screen-printed material of the connection pad reinforcement layer 46 is then dried in a ventilated box furnace at 150° C. for 15 minutes, before being fired in a ventilated box furnace at 550° C. for a total time of 35 minutes, including 5 to 7 minutes at the peak temperature.

### Electric Connections to the Heater Assembly

The screen printed layers of dielectric material and heater track material are relatively fragile, compared to the surfaces of a conventional heater assembly. Therefore, it is relatively difficult to form strong and reliable electrical connections to the heater tracks, since standard joining methods that damage the delicate layers of the heater assembly 30 cannot be used. Therefore, there is a need for an improved bonding method to form electrical connections to the heater tracks of a thick film printed heater that allow the power control circuitry 174 to connect to the heater tracks 61 and 62.

The inventors have found that conventional joining methods (such as soldering, resistance welding, and conductive adhesives) that are commonly used by the consumer electronics industry to make electrical connections, do not provide a reliable and repeatable solution for joining the connection pads of the heater tracks to the power control circuitry.

In the device of the present disclosure, a technique known as ribbon-bonding was used to form strong and reliable electrical connections to the PSU connection pad 72, battery connection pad 73 and the common ground pad 74. Beneficially, the resultant electrical connections were found to be repeatable, reliable and can be mass manufactured.

Ribbon-bonding is a type of ultrasonic bonding. Ultrasonic bonding involves the use of force, time and ultrasonics to join two materials. The ribbon or wire is pressed against the surface (both at ambient temperature) at low force and vibrated for a limited period of time to achieve the bond. Ultrasonic energy, when applied to the metal to be bonded, renders it temporarily soft and plastic. This causes the metal to flow under pressure. The acoustic energy frees molecules and dislocates them from their pinned positions and that allows the metal to flow under the low compressive forces of the bond. Thus heat at the bond site becomes a bi-product of the bonding process and so external heat is not necessary. Such ultrasonic bonding is also called a “cold weld”. There are two types of ultrasonic bonding: wedge bonding and tape automated bonding (TAB). Wedge bonding (which includes ribbon bonding) is preferred as there is more control over the placement of the wires (in TAB bonding, the wire is already pre-aligned over the pad to which it is to be bonded).

The bonding parameters used to form the ribbon bonds are important for forming strong and reliable connections. The ultrasonic voltage used to form the ribbon bonds may be, for example, between 40 V and 110 V, preferably between 50 V and 80 V. The bond force used to form the ribbon bonds may be, for example, between 1500 cN and 5000 cN, preferably between 4500 cN and 5000 cN. The phase duration used to form the ribbon bonds may be, for example, between 200 ms and 500 ms, preferably between 300 ms and 500 ms.

The ‘ribbon leave out angle’ is the angle at which the ribbon extends away from the joining surface. The ribbon leave out angle may be, for example, between 10 degrees and 80 degrees. A ribbon leave out angle of between 20 degrees and 50 degrees was found to be particularly beneficial for reducing the stress on the ribbon bonds.

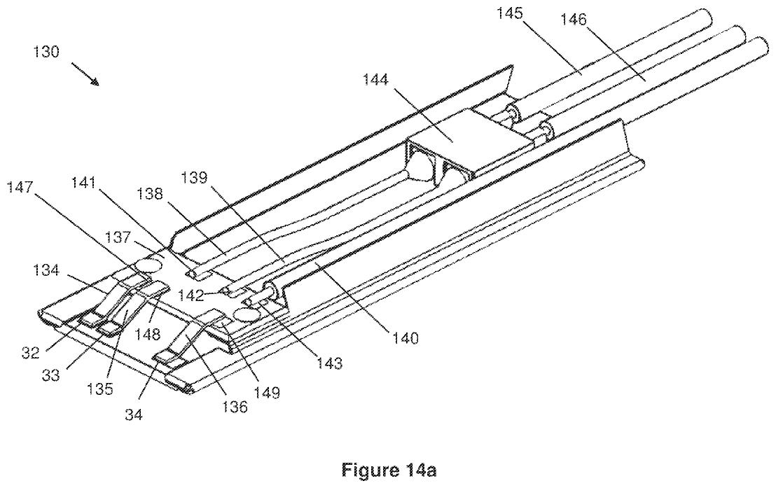

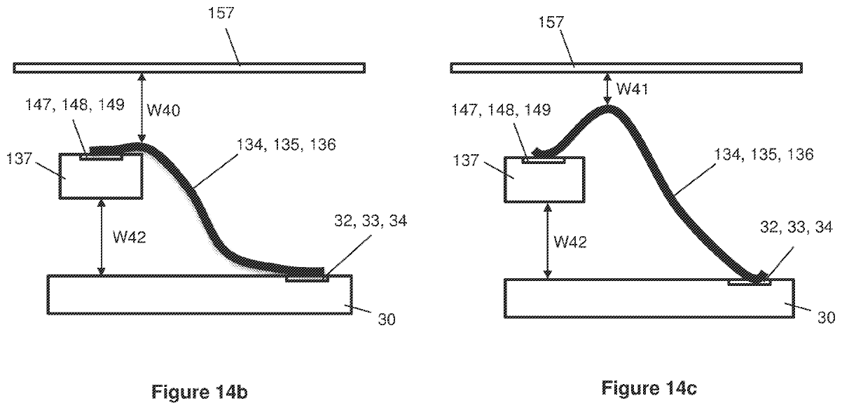

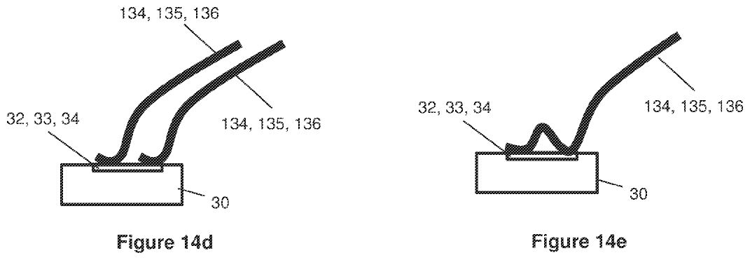

FIG. 14a illustrates an electrical connection assembly 130, showing an electrical connection to the connection pads 32 to 34 of the heater assembly 30. As shown in the figure, the connection pads 32 to 34 are connected to a bridge 137 by ribbon bonds 134, 135 and 136 respectively. The bridge 137 provides an intermediate joining point for the electrical connections between the heater tracks and a main PCB (not shown) of the styling device 20 carrying the control and power drive electronics shown in FIG. 2c. The bridge 137 comprises a PCB formed of a standard PCB stackup comprising layers of gold, nickel and copper, suitable for bonding to a wide range of electrical connections. To reduce the propensity for warping, the number of layers in the PCB is preferably an even number.

In one example, the PCB stackup may comprise a layer of FR4 (a glass-reinforced epoxy laminate material) of between 0.8 mm and 3.2 mm thickness. A first copper layer of approximately 0.035 mm thickness is arranged on top of the FR4 layer. Two or more ‘PrePreg 1080’ layers of approximately 0.140 mm thickness are arranged on top of the copper layer. A second copper layer of approximately 0.035 mm thickness is arranged on top of the PrePreg 1080 layer. An electroless Ni layer of approximately 0.0025 mm to 0.008 mm thickness is arranged on top of the second copper layer. A layer of immersion gold of approximately 0.05 μm to 0.15 μm thickness is arranged on top of the electroless Ni layer. However, it will be appreciated that any other suitable configuration of the PCB stackup may be used.

Advantageously, the ribbon bonds 134 to 136 form strong and reliable connections to the pads 32 to 34 of the heater assembly 30, and the bonding process does not damage the relatively delicate thick film printed layers of the heater assembly 30. A first ribbon bond 134 connects the PSU connection pad 32 to a first intermediate connection pad 147 on the ribbon side of the bridge 137. A second ribbon bond 135 connects the battery connection pad 33 to a second intermediate connection pad 148 on the ribbon side of the bridge 137. A third ribbon bond 136 connects the common ground pad 34 to a third intermediate connection pad 149 on the ribbon side of the bridge 137.

The ribbon bonding process is a relatively clean joining method that does not require epoxy. Each ribbon bond may be formed by first connecting an end of the ribbon to a connection pad of the heater assembly 30, and then connecting the other end of the ribbon to the corresponding pad on the bridge 137. Alternatively, each ribbon bond may be formed by first connecting an end of the ribbon to a connection pad of the bridge 137, and then connecting the other end of the ribbon to the corresponding pad of the heater assembly 30.

The ribbons form ‘step-up’ connections from the connection pads of the heater assembly 30 to the corresponding connection pads on the PCB of the bridge 137. As illustrated in FIGS. 14b and 14c, the ribbon bonds may be configured in a ‘tight’ configuration or a ‘looped’ configuration. As illustrated in FIG. 14c, in the ‘looped’ configuration the length of the ribbon is significantly longer than the length of the shortest path between the bonding points. FIGS. 14b and 14c also illustrate the vertical offset W42 between the heater assembly 30 and the bridge 137. Beneficially, increasing the offset W42 reduces the heat transfer from the heater assembly 30 to the bridge 137. However, the offset W42 is limited by the clearance W40 required between the ribbon and the upper casing 157 of the arm of the device.

FIG. 14b shows a ribbon in the ‘tight’ configuration. Beneficially, the ‘tight’ configuration provides a relatively large clearance W40 between the ribbon and the upper casing 157, allowing the offset W42 between the heater assembly 30 and the bridge 137 to be reduced (or the size of the casing to be reduced). The ‘tight’ configuration is particularly suitable when there is no relative movement between the bridge 137 and the heater assembly 30. However, the ‘tight’ configuration causes the electrical connections to experience a relatively high strain if there is relative movement between the bridge 137 and the heater assembly 30.

FIG. 14c shows a ribbon in the ‘looped’ configuration. Beneficially, the ‘looped’ configuration reduces the strain on the electrical connections when there is relative movement between the heater assembly 30 and the bridge 137. For example, relative movement between the heater assembly 30 and the bridge 137 may occur, in use, when a ‘floating’ heater assembly is provided in the arm of the device (e.g. a heater assembly mounted to an arrangement of springs or other resilient material). However, in the ‘looped’ configuration the clearance W41 between the ribbon and the upper casing 157 is reduced.

As illustrated in FIG. 14a, the bridge 137 further comprises first 141, second 142 and third 143 general connection pads on the opposite side of the bridge 137 to the ribbon bonds, that are electrically connected to the first 147, second 148 and third 149 intermediate connection pads, respectively. Advantageously, since the general connection pads are formed on the standard PCB material of the bridge 137, a wide range of conventional joining methods can be used to join to the general connection pads 141 to 143 to form the desired electrical connection to a main PCB of the styling device 20.

As illustrated in FIG. 14a, in this embodiment, the first general connection pad 141 is connected to a PSU power wire 145 via fuse 144 and a first intermediate wire 138. The second general connection pad 142 is connected to a battery power wire 146 via the fuse 144 and a second intermediate wire 139. The third general connection pad 143 is connected to ground via a ground wire 140. It will be appreciated, therefore, that the connection pads of the heater assembly 30 are connected to the main PCB of the hair styling device 20 via the ribbon bonds and the intermediate bridge 137. Whilst the ribbon bonds could, in theory, connect directly from the connection pads of the heater assembly 30 to the main PCB of the hair styling device 20, the provision of the intermediate bridge 137 beneficially reduces the strain on the electrical connections, as described in more detail below.

By providing the bridge 137, the ribbons can be terminated at the intermediate PCB of the bridge 137, rather than being connected directly a main PCB of the device 20. Beneficially, the provision of the bridge 137 between the ribbons and the wires to the main PCB of the device 20 reduces the strain on the ribbon bonds to the heater tracks, reducing the risk of failure of the connection. In particular, when the heater plates are configured to ‘float’ within the corresponding arm of the hair styling device 20, the bridge 137 reduces the strain on the ribbon bonds as the heater assembly moves, since the bridge 137 does not move relative to the heater assembly (i.e. the bridge 137 is in a fixed position relative to the heater assembly 30). Instead, the strain is applied at the general connection pads of the bridge 137. However, since a wide range of bonding techniques can be used to bond to the general connection pads, a stronger and more robust bonding method can be used to mitigate against such movement-induced strain, without risk of damaging the relatively delicate layers of the heater assembly 30. Moreover, the provision of the bridge 137 shortens the lengths of the ribbons required to form the connections from the heater assembly 30, compared to if the ribbons instead connected the connection pads of the heater assembly 30 directly to the main PCB of the hair styling device 20.

Multiple ribbons may be used to form a connection between one of the connection pads of the heater assembly and the corresponding pad of the bridge 137. Advantageously, this configuration maintains an electrical connection between a connection pad of the heater assembly 30 and the corresponding connection pad of the bridge 137, even when one of the ribbon bonds fails. FIG. 14d shows an example in which a pair of ribbons are bonded to a connection pad. Similarly, as illustrated in FIG. 14e, each ribbon may be bonded to the connection pad at multiple locations along the length of the ribbon—so that if one of the bonds fails, an electrical connection is still provided at the other bonding locations.

In a presently preferred embodiment, the ribbons are formed of aluminium. Beneficially, aluminium was found to form particularly strong and reliable bonds to the silver based material of the connection pads. However, the ribbons need not necessarily be formed of aluminium. For example, the ribbons could instead be formed of copper, silver, gold, aluminium cladded copper, or platinum.

Whilst the aluminium ribbons form particularly strong and reliable connections to the connection pads of the heater assembly 30, the aluminium material has a relatively low conductivity compared to commonly used metals for electrical connections (for example, copper). Therefore, in this example, the ribbon bonds have a relatively large thickness of approximately 400 μm. This particularly thick ribbon allows sufficient current to be carried to the tracks of the heater assembly 30. However, it will be appreciated that the ribbons need not necessarily be 400 μm thick. For example, thicknesses of between 100 μm and 500 μm could be used. Advantageously, the use of relatively thick ribbons also increases the mechanical strength of the ribbon bonds, reducing the risk of failure of the electrical connections. The ribbons used to form the ribbon bonds may be, for example, between 1 mm and 2 mm wide. A ribbon thickness of 400 μm and a ribbon width of 2 mm was found to be particularly beneficial when aluminium ribbon is used, since this allows sufficient current to be carried, and enables strong and reliable electrical connections to be formed.

### Mounting Assembly

Conventional hair styler plate geometries typically contain non-flat edge features for facilitating mounting of the heater plate to the casing. However, with a screen printing process for manufacturing the heater assembly 30 it is desirable that the aluminium substrate 41 is flat on the side on which the thick film layers are printed, so that the printer rollers of the screen printing process are not obstructed. It is also desirable for the hair contacting surface 52 on the other side of the aluminium substrate 41 to be flat, so that the heater plate can effectively engage with the hair to be styled. Therefore, there is a need for an improved mounting assembly for mounting the heater assembly 30 to an arm 22 of the hair styling device 20, that does not obstruct the screen printing process.

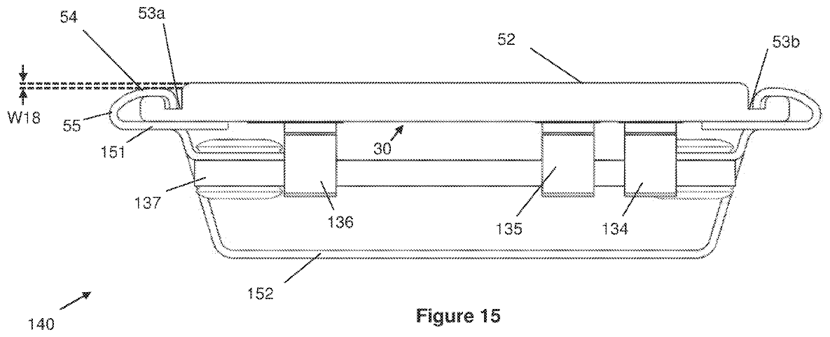

FIG. 15 shows a transverse cross section of a mounting assembly 140 including a mounting clip 151 for retaining the heater assembly 30 inside an arm 22 of the device 20. The mounting clip 151 engages with the first and second channels 53a and 53b that extend longitudinally along the outer surface of the aluminium substrate layer 41, and engages with an interior surface of the arm housing of the hair styling device 20. As illustrated in FIG. 15, the first and second channels are provided towards the edges of the outer surface (i.e. the channels are provided in edge portions of the outer surface).

The central hair contacting surface 52 may be provided with an additional coating (e.g. to increase the smoothness or visual appeal of the hair contacting surface), which need not necessarily also be provided in the edge portions (although may also be provided in the edge portions).

The mounting clip 151 retains the heater assembly 30 (and the corresponding electrical connection assembly 130) inside the arm 22 of the device 20. Advantageously, the mounting clip 151 has relatively low thermal contact with the heater assembly 30, which increases the efficiency of the device 20 by reducing the amount of heat that is wasted by transfer to the mounting clip 151 and from the mounting clip to the housing of the arm 22. Moreover, the mounting clip 151 has a relatively low thermal mass (for example, less than 5 J/K) compared to a conventional heater carrier, further increasing the efficiency of the device.

As illustrated in FIG. 15, the edge portions of the outer surface are recessed relative to the central hair contacting surface 52. As can be seen in the figure, an outer surface 54 of the mounting clip 151 is offset from the hair contacting surface 52 of the aluminium substrate 41 by a height W18. The hair contacting surface 52 protrudes beyond the outer surface 54 of the mounting clip 151. The offset ensures that the hair contacting surface 52 of the aluminium substrate 41 is sufficiently exposed to engage with the hair to be styled.

As shown in the Figure, the mounting clip 151 comprises a curved portion 55 at each side of the clip 155 that engages with the respective longitudinal groove 53 in the upper surface 52 of the substrate 41, to grip the substrate 41 and hold the substrate 41 (and therefore the heater assembly 30) to the housing of the arm 22. The radius of curvature of the curved portion 55 may be configured to reduce a crimping effect on the hair being styled, as the hair is pulled through the device 20. The mounting clip 151 is attached to the housing at the rear wall 152. This may be achieved by using a suitable fastener such as a screw. Alternatively, the mounting clip 151 can be shaped so that it is held in place by suitable friction fit between the mounting clip 151 and the housing of the arm 22.

Advantageously, the configuration of the mounting assembly 140 and the heater assembly 30 is such that the heater assembly 30 can be mounted to an arm 22 of the device 20, whilst providing smooth surfaces of aluminium substrate for compatibility with the screen printing process.

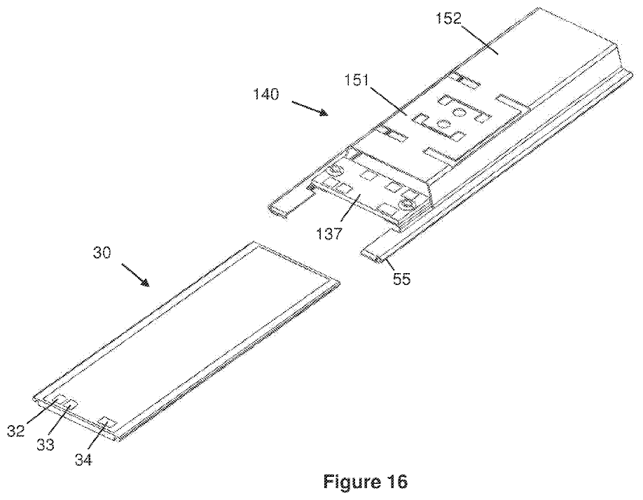

FIG. 16 shows an overview of the heater assembly 30 and the mounting assembly 140, showing the relative arrangement of the intermediate bridge 137 and the mounting clip 151.

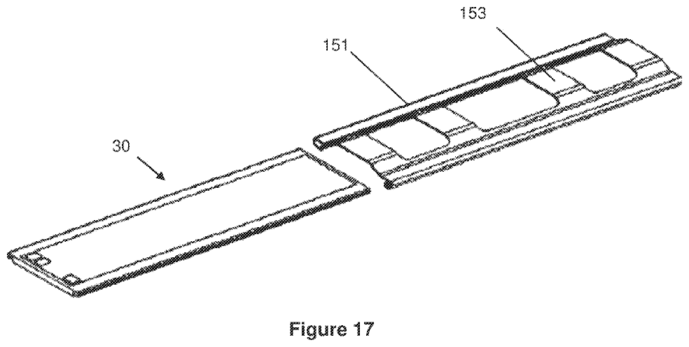

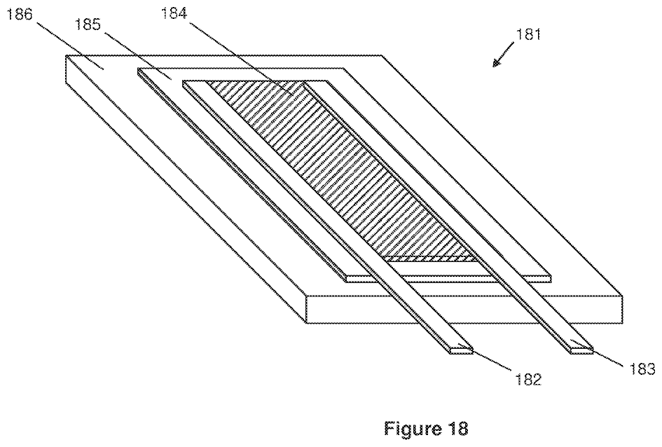

FIG. 17 shows an alternative configuration of the mounting clip 151 (for clarity, the intermediate bridge 137 is not shown) in which the mounting clip 151 includes a plurality of discrete surfaces 153 for engaging with the inner surface of the arm housing of the hair styling device 20. Advantageously, this reduces the surface area of the clip 151 that engages with the inner surface of the arm housing, reducing the thermal transfer from the heater assembly 30 to the housing, and further increasing the thermal efficiency of the hair styling device 20.

### Alternative Heater Assembly Configuration

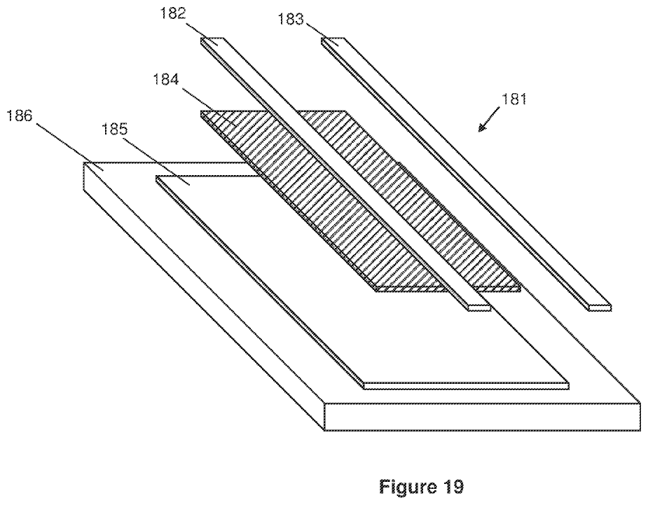

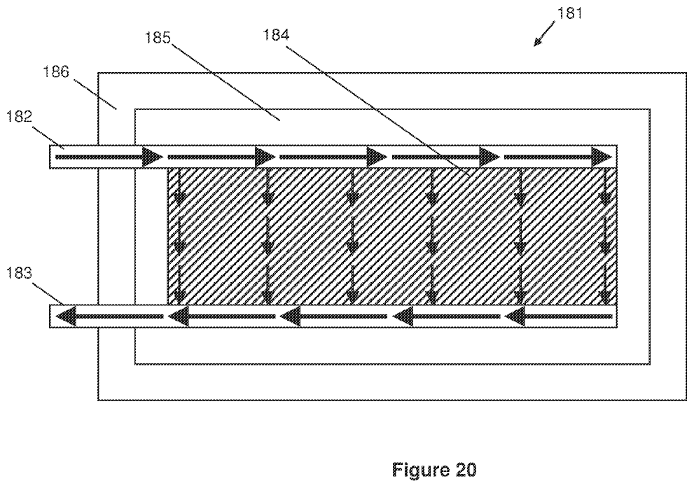

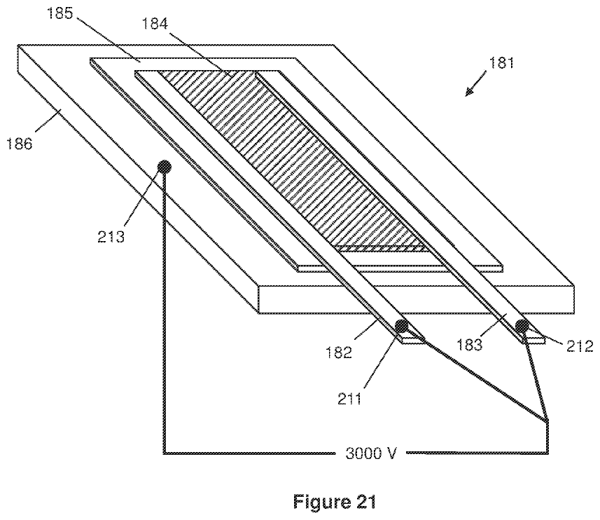

A further example of a heater assembly that could be used as part of the device 20 will now be described with reference to FIGS. 18 to 21. FIG. 18 shows an overview of a heater assembly 181 comprising a pair of bus bars 182, 183 (which may be referred to as first and second elongate conductive elements) arranged either side of a heating element 184 (which may be referred to as a resistive heating element). The bus bars 182, 183 are low resistance elements that allow current to flow along their length, and have a lower electrical resistance than the heating element 184. In this example the bus bars 182, 183 are formed from copper, but any other suitable electrically conductive material may alternatively be used (e.g. gold). The copper bus bars 182, 183 may have a thickness of approximately 0.3 mm. As illustrated in the exploded view shown in FIG. 19, electrically insulating material 185 is arranged between the heating element 184 and a substrate 186. The electrically insulating material and the substrate 186 may be formed as described above (e.g. using dielectric material that is screen printed onto an aluminium substrate), to prevent electrical breakdown between the heating element 184 and the substrate 186. As described above, the electrically insulating material 185 may be formed of a single layer of material, or alternatively may be formed of multiple layers of electrically insulating material (e.g. two layers). As shown in the figures, the heating element 184 is formed of a sheet of electrically conductive material arranged between the bus bars 182, 183. The heating element 184 may be formed, for example, from a layer of Ti6Al4V material. However, any other suitable material may alternatively be used to provide the required resistance for the particular heater assembly geometry. The thickness of the heating element 184 may be, for example, approximately 2.7 μm. The heating element 184 may be formed using any suitable technique (e.g. screen printing, or a physical vapor deposition (PVD) process in which a deposited material is sputtered onto a target material). Advantageously, the PVD process provides particularly precise control of the thickness of the heating element 184, enabling the thickness of the layer to be more uniform (and therefore the heat output to also be more uniform).

The heating element may be deposited (e.g. using the PVD process) before the bus bars are mounted. This enables a particularly uniform layer to be formed for the heating element 184, resulting in more uniform heating of the substrate 186. As shown in FIG. 18, the heating element 184 is arranged between the bus bars 182, 183. However, it will be appreciated that the bus bars 182, 183 may overlap (or partially overlap) the heating element 184. In use, a voltage is applied across bus bars 182, 183, resulting in a flow of current across the heating element, and a corresponding output of heat to heat the substrate 186. This flow of current is illustrated schematically by the arrows shown in FIG. 20. Advantageously, the use of the bus bars 182, 183, and the generally planar layer of electrically conducting material 184 between the bus bars, enables a particularly uniform output of heat, and is also easier to manufacture using PVD.

FIG. 21 shows an illustration of a voltage breakdown test that can be applied to the heater assembly 181. The test may be referred to as a ‘mains compliance test’. As shown in the figure, a voltage (in this example, a 3000 V AC voltage) is applied across the bus bars 182, 183 and the substrate 186, using contact points 211, 212 on the bus bars and a contact point 213 on the substrate. The voltage breakdown test may be used to ensure that no electrical breakdown occurs across the electrically insulating layer 185. It will be appreciated that the electrically insulating layer 185 may be configured for preventing electrical breakdown at a voltage corresponding to a mains electrical supply when the heater is powered at the mains voltage, or alternatively may be configured for preventing electrical breakdown at a lower voltage (e.g. less than 43 Volts) corresponding to a supply of power from a battery or other low-power power supply (similarly, the electrically insulating layers 42, 43 illustrated in the example shown in FIG. 4 may also be configured for preventing electrical breakdown at a relatively low voltage for battery powered tracks, or at a higher mains voltage).

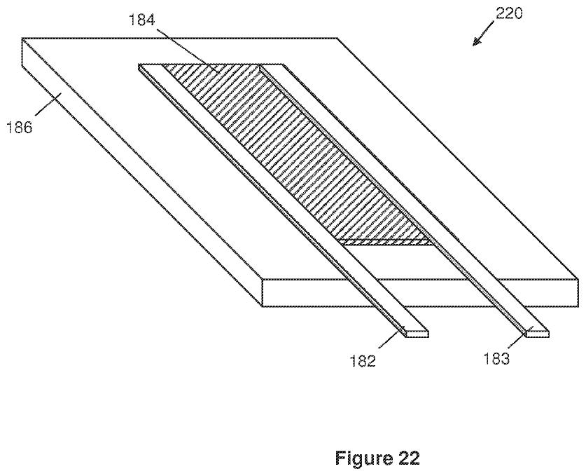

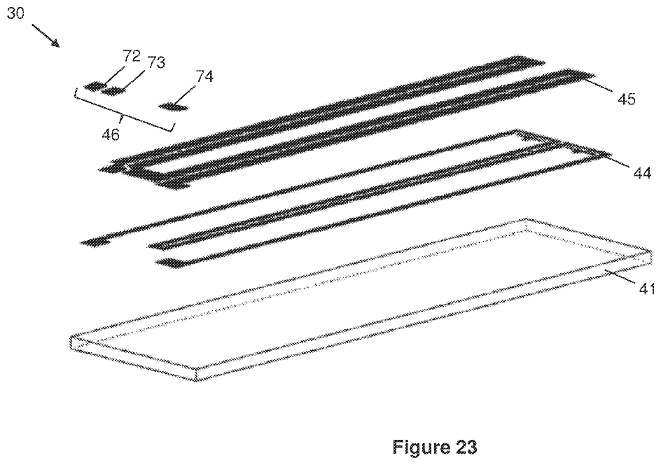

FIG. 22 shows a modification of the heater assembly 181 of FIG. 18, in which the heating element 184 is arranged directly on the substrate 186. In this example, the substrate 186 is formed from an electrically insulating but thermally conductive material. The substrate 186 may be formed, for example, from aluminium nitride or beryllium oxide, although any other suitable electrically insulating material and thermally conductive material could alternatively be used. When aluminium nitride or beryllium oxide is used, the thickness of the substrate may be, for example, between 0.2 and 1.5 mm, to provide sufficient mechanical strength and to ensure that there is sufficient electrical insulation between the heater electrode and the outer surface of the substrate (which may contact the user, in use). Advantageously, the provision of an electrically insulating substrate 186 removes the need for the separate layer of electrically insulating material 185 to be provided between the heating element 184 and the substrate 186. As described above, reducing the number of layers that form the heater assembly reduces the manufacturing complexity and reduces the propensity for warping of the assembly 220 during manufacture. Moreover, since the substrate 186 is electrically insulating, the heater assembly 220 can be operated using a relatively high mains voltage, without the need for a relatively thick layer of electrically insulating material 185 to avoid electrical breakdown at such voltages. An electrically insulating substrate could also be used in the example described above with reference to FIG. 4. For example, FIG. 23 shows a modified version of the heater assembly of FIG. 4, in which the substrate 41 is formed from an electrically insulating material and the dielectric layers 42, 43 are not provided.

### Curved Substrates

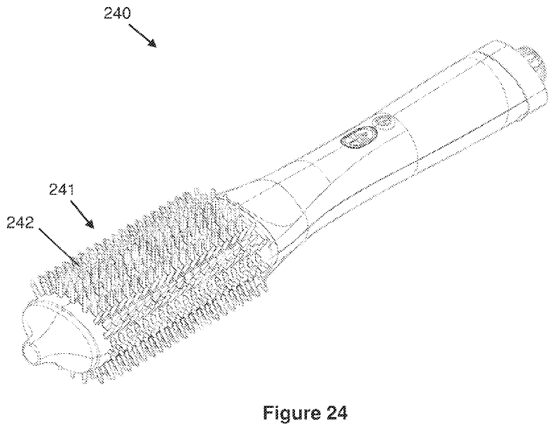

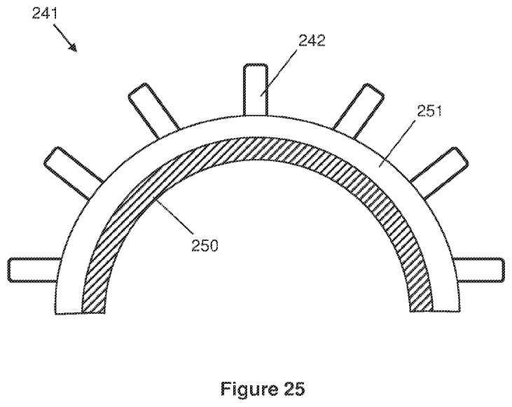

FIG. 24 shows an example of a further type of device 240 that may include a heater assembly comprising a curved substrate. The device 240 shown in FIG. 24 is a heated brush having a head portion 241 comprising a plurality of heated bristles 242. It will be appreciated that the device 240 shown in FIG. 24 is merely an example of a type of device that may comprise a heater assembly having a curved (e.g. convex or concave) substrate, and any other suitable device could alternatively be used. FIG. 25 shows a partial cross section of the head portion 241, in which the curved substrate 251 is shown. The other layers 250 of the heater assembly (the electrically insulating layer(s) and the heating element(s)) are arranged for transfer of heat to the substrate and subsequent transfer of heat to the user's hair, in use. As described above, a layer 185, or layers, of electrically insulating material may be included between the heater electrode and the substrate 251, but need not necessarily be provided if the substrate 251 is electrically insulating. The layers 250 of the heater assembly may be formed on the curved substrate 251 using PVD. Advantageously, the PVD method of manufacture enables accurate control of the thickness of the deposited layers (particularly when the substrate is curved, compared to alternative methods), and a more uniform heater electrode layer beneficially reduces the occurrence of local hot spots (since the resistance of the heater electrode, and therefore the heat output, depends on the thickness of the electrically conductive material).

### Modifications and Alternatives

Detailed embodiments and some possible alternatives have been described above. As those skilled in the art will appreciate, a number of modifications and further alternatives can be made to the above embodiments whilst still benefiting from the inventions embodied therein. It will therefore be understood that the invention is not limited to the described embodiments and encompasses modifications apparent to those skilled in the art lying within the scope of the claims appended hereto.

Whilst the layers of the heater assembly 30 have been described in some examples as being formed using a thick film printing process, it will be appreciated that some of the benefits of the disclosure do not require the layers to have been thick film printed. For example, the benefits of the non-constant widths of the PSU track and the battery track to improve the heat distribution across the hair contact surface to not require the tracks to have been formed using a thick film printing process. Alternatively, the tracks could be formed, for example, by depositing silver (or another suitable conductive material) using a method such as electroplating (also known as electrodeposition), electroless plating, physical vapour deposition, ion assisted deposition or atomic layer deposition.

Whilst in the above examples the first and second dielectric layers have been described as being rectangular, this need not necessarily be the case. The first and second dielectric layers may have any other suitable geometry.

Whilst the reinforcing pads of the connection pad reinforcement layer 46 have been described above as being formed of the same material used to form the battery track layer 45, it will be appreciated that this need not necessarily be the case. Any other suitable conductive material may be used to form the connection pad reinforcement layer 46.

It will be appreciated that when two hair contacting plates are provided (for example, as shown by the two hair contacting plates of the device illustrated in FIG. 2a), either one or both of the plates could be heated. For example, the heater assembly 30 could be provided in the lower arm 22a only to heat the lower hair contacting surface 52a, could be provided in the upper arm 22b only to heat the upper hair contacting surface 52b, or a pair of heater assemblies 30 could be provided (one provided in each arm) to heat the lower hair contacting surface 52a and the upper hair contacting surface 52b.

Any or all of the main body of the device 20 illustrated in FIG. 2a may be formed of a unitary structure, e.g. by 3D printing.

Whilst in this particularly advantageous example a PSU track and a battery track are provided, it will be appreciated that the heater assembly may alternatively be configured with only a PSU track (for a device powered directly by mains power without a cordless mode of operation) or with only a battery track. It will be appreciated, therefore, that the number of heater tracks (and corresponding heater track layers) need not necessarily be two. Alternatively, three or more stacked heater tracks, possibly separated by additional dielectric layers, could be provided.

In the above-described examples, the PSU track 62 and/or the battery track 61 may be configured to operate as a temperature sensor. As the temperature of the heater track changes, the resistance of the heater track also changes according to a predetermined relationship (which may be determined in a calibration routine). Therefore, by measuring the resistance of the heater track, the temperature (or change in temperature) of the heater track can be determined and used by the controller for controlling the temperature of the heater assembly. The controller can measure the resistance of the relevant track in various different ways. For example, the controller can apply, or cause to be applied, a known voltage to the track and measure the current flowing through (or voltage drop across) a resistance of known value that is connected to the track. Beneficially, the provision of two (or more) independently operable heater tracks allows one of the tracks to be operated as a temperature sensor when the other heater track is operated to heat the heater assembly. For example, when the device 20 is operating in a mode in which the PSU track 62 is used for heating, the battery track 61 may be operated as a temperature sensor. When the device 20 is operating in a mode in which the battery track 61 is used for heating, the PSU track 62 may be operated as a temperature sensor. The controller then selects which of the heater tracks is to be used to heat the substrate (heater assembly) and selects which of the heater tracks is to be operated as a temperature sensor. The controller may be configured to select between a first mode in which both the battery track 61 and the PSU track 62 are used for heating, a second mode in which the battery track 61 is used for heating and the PSU track 62 is operated as a temperature sensor, and a third mode in which the PSU track 62 is used for heating and the battery track 61 is operated as a temperature sensor. Alternatively, one or both of the heater tracks 61, 62 may be operated simultaneously for heating and as a temperature sensor.

The device 20 may be provided with auxiliary sensors, for example hair sensors for detecting the presence of hair on one of the hair contacting surfaces. The device 20 may comprise one or more moisture sensors for determining a moisture content of the hair on a hair contacting surface of the device 20. The operation of the heater tracks may then be controlled based on the measurements of the one or more moisture sensors. Alternatively, the moisture content of the hair may be inferred from a change in temperature of at least one of the heater tracks or the hair contacting surfaces.

In the above description the configuration of the layers of the heater assembly 30 have been described as reducing the propensity for warping of the device. Alternatively, the layers may be configured (for example, by increasing the number of layers of dielectric material) to achieve controlled warping of the heater assembly during a curing process, resulting in the hair contacting surface having a bowed shape. Alternatively, a heater assembly having a bowed shape may be obtained by bending the heater assembly after the screen printing process, by applying a force to the heater assembly. In a further alternative, the electrically insulating material and heater tracks may be printed onto a curved substrate (for example, using a pad/tampon printing method). In a further alternative, as described above, the electrically insulating material and/or heater electrode may be deposited onto a curved substrate using PVD. A bowed (concave or convex) or curved hair contacting surface may be desirable for some types of hair styling device, for example to corral the hair into a central region of the hair styling surface when the surface is concave.

Whilst in the preferred embodiment illustrated in FIG. 14a the intermediate bridge 137 is provided, this need not necessarily be the case. Alternatively, the ribbons could connect the connection pads of the heater assembly 30 directly to a main PCB of the device 20 that carries the power control circuitry 174. Whilst this alternative would retain some of the benefits of using ribbon bonding to form a strong connection to the connection pads without damaging the delicate layers of the heater assembly 30, the mechanical strain on the connections would be increased compared to the preferred embodiment in which the bridge 137 is provided, due to the increased length of ribbons and strain induced by any relative movement between the heater assembly 30 and the main PCB.

Whilst in the preferred embodiment illustrated in FIG. 14a ribbon bonding is used to form the connections to the connection pads of heater assembly 30 (which provides the benefits of particularly strong and reliable bonds, a low unit production cost, high yield, and a fully automated process), alternatively another suitable type of bonding may be used to electrically connect the end of a conductor to the connection pads. For example, tape automated bonding (TAB) could be used when the ribbon is pre-aligned over the connection pad to which it is to be bonded. Alternatively, direct joining of copper wires with high temperature solder could be used. An epoxy could then be used to pot each joint for added strength. In a further alternative, brass connectors (to which copper wires can be attached) could be joined to the power input pads using an electrically conductive adhesive, and the connections could then be reinforced with an electrically insulating high temperature epoxy. It will be appreciated that the benefits of the heater track geometry, heater assembly configuration, and the mounting clip configuration are nevertheless achieved even when alternative methods of forming electrical connections to the heater tracks are used.

Whilst in some of the examples above electrical insulation between a heater electrode and a substrate has been described as being provided by a separate electrically insulating layer (e.g. screen printed dielectric material, or dielectric material deposited using PVD) arranged between the heater electrode and the substrate, this need not necessarily be the case. The electrical insulation could alternatively, or additionally, be provided by applying a surface treatment to the substrate in order to form an electrically insulating barrier from the substrate material. For example, when the substrate is metallic (e.g. aluminium), the surface of the substrate could be treated using a plasma electrolytic oxidation (PEO) process, or a NANOCERAMIC Electro Chemical Oxidation (ECO) process to form an electrically insulating oxide layer. The PEO process may comprise, for example, applying a voltage of approximately 300 V and using an alkaline solution at approximately 15 to 20° C. to form a layer of micro-crystalline aluminium oxide. The micro-crystalline aluminium oxide may have a thermal conductivity of approximately 1 to 2 W/mK, and a dielectric strength of approximately 10 to 30 KV/mm. The thickness of the surface treatment in the PEO process may be, for example, between 0.01 and 0.4 mm. The ECO process may comprise applying a voltage of approximately 400 V using controlled shape bipolar pulses, and a room temperature colloidal alkaline solution, to form a layer of nanocrystalline aluminium oxide. The layer of nanocrystalline aluminium oxide may have a thermal conductivity of approximately 7 W/mk and a dielectric strength of approximately 50 KV/mm. The thickness of the surface treatment in the ECO process may be, for example, between 0.005 and 0.3 mm. In a further alternative, a hard anodising technique could be used to form the electrically insulating layer. The hard anodising technique may comprise applying a relatively low voltage (e.g. below 300 V), and using a concentrated acidic electrolyte at approximately 0° C., to form Al Hydroxide Amorphous and Al Oxide in a column-like structure. The thickness of the surface treatment in the hard anodising process may be, for example, between 0.05 and 0.6 mm. Advantageously, the oxide layer formed in the hard anodising, PEO and ECO methods increases the electrical insulation between the heater element and the conductive part of the substrate, without compromising the thermal conductivity that is needed to transfer heat from the heater element to the substrate for heating the user's hair.

In the above-described examples the electrically insulating layers have been described as being formed, for example, of a silica (SiO₂) based material. However, this need not necessarily be the case, and any other suitable material could be used to form the electrically insulating layers. For example, a polymer dielectric material (e.g. polyimide membrane or varnish) may be used, or a solvent-based silicone resin comprising inorganic fillers could be used.

Throughout the description and claims of this specification, the words “comprise” and “contain” and variations of the words, for example “comprising” and “containing”, means “including but not limited to”, and is not intended to (and does not) exclude other components, integers or steps.

1. A heater assembly for a hair styling device, the heater assembly comprising:
a substrate;
at least one conductor layer mounted to the substrate, the at least one conductor layer comprising conductors that define at least one heater track through which current can flow to heat the substrate; and
connection circuitry for connecting the at least one heater track to power control circuitry for causing current to flow through the at least one heater track;
wherein the connection circuitry includes a conductive member that is ultrasonically bonded to the at least one heater track.

2. The heater assembly according to claim 1, the heater assembly further comprising:
an intermediate connection member,
wherein the conductive member is ultrasonically bonded to a first connection terminal of the intermediate connection member, to electrically connect the at least one heater track to the first connection terminal,
wherein the intermediate connection member comprises a second connection terminal that is electrically connected to the first connection terminal, and
wherein the power control circuitry is electrically connected to the second connection terminal for causing current to flow through the at least one heater track via the intermediate connection part.

3. The heater assembly according to claim 2,
wherein the conductive member is a ribbon of conductive material, and
wherein the conductive member is ribbon bonded to the at least one heater track.

4. The heater assembly according to claim 3, wherein the ribbon is an aluminium ribbon.

5. The heater assembly according to claim 3, wherein the ribbon has a thickness of between 100 μm and 500 μm.

6. The heater assembly according to claim 3, wherein the ribbon has a width of between 1 mm and 2 mm.

7. The heater assembly according to claim 3, wherein the ribbon between the ultrasonic bond to the heater track and the first connection terminal has a loop portion.

8. The heater assembly according to claim 3, wherein a length of the ribbon between the ultrasonic bond to the heater track and the first connection terminal is substantially longer than a shortest connection path between the ultrasonic bond to the heater track and the first connection terminal.

9. The heater assembly according to claim 1, wherein the conductive member is ultrasonically bonded at a plurality of discrete connection points to a connection terminal of the at least one heater track.

10. The heater assembly according to claim 1, wherein a plurality of the conductive members are ultrasonically bonded to a single connection terminal of the at least one heater track.

11. The heater assembly according to claim 1, further comprising at least one dielectric layer between the substrate and the at least one conductor layer.

12. The heater assembly according to claim 11, wherein the at least one dielectric layer has a total thickness of between 0.02 mm and 0.05 mm.

13. The heater assembly according to claim 11, wherein the at least one dielectric layer comprises two dielectric layers;
wherein a first dielectric layer of the two dielectric layers has a thickness of between 0.01 mm and 0.025 mm; and
wherein a second dielectric layer of the two dielectric layers has a thickness of between 0.01 mm and 0.025 mm.

14. The heater assembly according to claim 1, wherein the substrate is concave or convex, and wherein the at least one conductor layer is formed using a physical vapour deposition, PVD, process.

15. A hair styling device comprising one or more heater assemblies according to claim 1.

16. The hair styling device according to claim 15, wherein the hair styling device comprises a controller; and
wherein the at least one heater track comprises a first heater track and a second heater track, and the controller is configured to be able to select either one of the first or second heater tracks to be operated to heat the heater assembly, and to select the other of the first or second heater tracks to be operated as a temperature sensor.

17. The hair styling device according to claim 16, wherein
the first heater track is a power supply unit, PSU, heater track that is connected to power control circuitry for flow of current derived from a mains power source, and the second heater track is a battery heater track that is connected to power control circuitry for flow of current derived from a battery power source.
